(19) United States
(12) Patent Application Publication
(10) Pub. No.: US 2026/0211906 A1
(43) Pub. Date: Jul. 23, 2026

(54) AGGREGATING DATA INGESTED FROM DISPARATE SOURCES FOR PROCESSING USING MACHINE LEARNING MODELS

(71) Applicant: CITIBANK, N.A., New York, NY (US)

(72) Inventors: Deepali TUTEJA, Coppell, TX (US); Girish WALI, Flower Mound, TX (US); David Anandaraj ARULRAJ, Mason, OH (US); Miriam SILVER, Tel Aviv (IL)

(73) Assignee: CITIBANK, N.A., New York, NY (US)

(21) Appl. No.: 19/451,934

(22) Filed: Jan. 16, 2026

Related U.S. Application Data
(63) Continuation-in-part of application No. 19/322,550, filed on Sep. 8, 2025.
Application No. 19/322,550 is a continuation of application No. 19/215,019, filed on May 21, 2025, now Pat. No. 12,411,873.
Application No. 19/215,019 is a continuation of application No. 18/123,179, filed on Mar. 17, 2023, now Pat. No. 12,314,289.

(51) Int. Cl. G06F 16/28; G06F 16/21; G06F 16/25

(52) U.S. Cl. CPC G06F 16/287; G06F 16/213; G06F 16/258

(57) ABSTRACT

Presented herein are systems and methods for aggregating data from disparate sources using generative models. A computing system may retrieve, from a plurality of data sources, a first plurality of datasets for at least one of a plurality of features for a network environment over a first time period. The computing system may execute a first generative model using the first plurality of datasets to create a second plurality of datasets. The computing system may identify, from the second plurality of datasets, at least one dataset corresponding to a feature of the plurality of features. The one or more processors may execute select at least one machine learning model based on the feature. The computing system may execute the at least one ML model using the dataset to determine an output. The computing system may cause displaying of a visualization of the output via a graphical user interface.

### CROSS REFERENCE TO RELATED APPLICATIONS

The present application claims the benefit of and priority to under 35 U.S.C. § 120 as a continuation-in-part of U.S. application Ser. No. 19/322,550, filed Sep. 8, 2025 and titled “AGGREGATING DATA INGESTED FROM DISPARATE SOURCES FOR PROCESSING USING MACHINE LEARNING MODELS,” which claims the benefit of and priority to under 35 U.S.C. § 120 as a continuation of U.S. application Ser. No. 19/215,019, filed May 21, 2025 and titled “AGGREGATING DATA INGESTED FROM DISPARATE SOURCES FOR PROCESSING USING MACHINE LEARNING MODELS,” which claims the benefit of and priority to under 35 U.S.C. § 120 as a continuation of U.S. application Ser. No. 18/123,179, filed Mar. 17, 2023, and titled “AGGREGATING DATA INGESTED FROM DISPARATE SOURCES FOR PROCESSING USING MACHINE LEARNING MODELS,” each of which is incorporated herein by reference in their entireties.

### TECHNICAL FIELD

This application generally relates to managing databases in networked environments. In particular, the present application relates to aggregating data ingested from disparate sources for centralized processing using machine learning (ML) models.

### BACKGROUND

In a computer networked environment, various processes, applications, or services running on servers, clients, and other computing devices may produce an immense amount of data. The data from these sources may be communicated over the network for storage across a multitude of databases. Each database may be designated for storing and maintaining data for a single or a subset of processes, even within an application or service. Furthermore, each database may arrange and maintain pieces of this data in accordance with the specifications of the database, independently of other databases. Because the data is stored across multiple databases each with its own specifications, a network administrator may have to access each individual database to gain any visibility into a portion of processes in the network. As a result, the network administrator may be left with a myopic view of the overall network, as it may be difficult for the administrator to obtain insight into multiple aspects of applications accessed through the network from accessing individual databases. This issue may be exacerbated with the immense quantity of data stored across a myriad of different databases. Due to this difficulty in accessing data across the myriad of databases, any problems or issues affecting the performance of the processes, applications, or services accessed through the network may remain undiagnosed and unaddressed.

### SUMMARY

Disclosed herein are systems and methods for aggregating data from disparate sources to process and output information using machine learning (ML) models. Through a network environment (e.g., an enterprise including data center, branch offices, and remote users), end-users on client devices may access applications hosted on a multitude of servers. In this environment, the processes of one application may affect or be related to the processes of other applications within the network. In connection with running processes of the applications, the servers may produce vast quantities of data. The servers may provide the produced data for storage across a variety of databases. Even for a single application, the servers may store the data on different databases depending on the type of operation carried out for the application. Each database may store and maintain the data in accordance with its own different or disparate specifications, such as those for arrangement, formatting, and content, among others. In addition, these data may be characterized by heterogeneous and fragmented datasets, including unstructured logs, varying application metadata, inconsistent fields, and complex configurations, among others.

A user may view the data from these databases for further analysis and diagnosis in an attempt to gain insight into the operations of the applications or servers across the network environment. Because the data for a particular application or set of processes is stored in different databases, the user may have to resort to accessing individual databases to retrieve the data maintained therein. For instance, a network administrator may have to access a specific server for a certain application to obtain performance-related metrics for the application. Expanding this to metrics for applications accessible through the network, the user may have to manually retrieve the data from a myriad of databases associated with different operations or applications.

As a consequence, it may be very difficult for the user to gather holistic information across multiple applications or servers within the network environment (e.g., across an enterprise), resulting in the user having to spend enormous tedious and manual efforts to fetch the data from different databases. Even when the data is collected, the data may not be ready for immediate use, because the retrieved data may be stored in a different manner using particular formatting and specifics. Due to the inability to access data across multiple databases, any issues or problems affecting performance across multiple applications or servers within the network may remain undetected or unresolved. These issues may be exacerbated by the fact that while processes of one application may affect the processes of another or the same application, the data stored across multiple databases may not reflect these relationships.

Furthermore, there may be significant challenges due to the heterogeneous and fragmented nature of the collected data, where similar concepts are described differently, making it difficult to integrate and analyze data in an actionable manner. In analyzing and interpreting the data, statistical models and clustering techniques may be used. However, these models and techniques may be limited to evaluating statistical similarity in the data without the ability to ascertain semantic context. Furthermore, the statical models and clustering techniques may be unable to resolve the heterogeneous and fragmented nature of the collected data, leading to gaps in missed links or correlations. One approach to address these issues may be to use a semantic knowledge graph to identify semantically related data elements within the collected data. However, manually creating such semantic knowledge graphs may be labor-intensive and may result in imprecise and inaccurate relationships. This approach thus may still lead to gaps in missed links or correlations.

Another challenge with maintaining and analyzing the data may be with respect to data quality and validation to check whether the data is in a proper and compliant form for processing. This may be particularly challenging when the data vary, are inconsistent, and originate from disparate sources with different formats and schemes. One approach may be to use manually defined rules to perform quality assurance on the data, for example, by using regular expressions or Boolean logic. These rules, however, may be limited to detecting relatively simplistic violations, such as type mismatches, format errors, and null values. In addition, such rules may be inflexible, unable to adapt to a wide array of different data sources and changes in the data themselves. As a result, approaches that rely on rules may result in a contamination of the collected data, with data in improper and non-compliant form and unable to properly process.

To address these and other technical problems, a service may aggregate data from multiple data sources of the network environment using machine learning (ML) models in order to output information. The service may establish and maintain a set of ML models along with generative models to perform intake of data, process the data for evaluation, and generate outputs using the processed data, among others. The generative models may include generative pre-trained transformer (GPT), bidirectional encoder representations from transformers (BERT), or recurrent neural network (RNN), among others. The ML models may include models trained in accordance with supervised learning (e.g., an artificial neural network (ANN), decision tree, regression model, Bayesian classifier, or support vector machine (SVM)), models trained in accordance with unsupervised learning (e.g., clustering models), among others. The ML models may provide various outputs regarding the data of the environment, such as application function, application deployment, risk assessment, or project key performance indicators, among others.

The service may access multiple databases to ingest the data therein over a sampling period. With the aggregation of the data, the service may execute an intake generative model to perform data quality and validation on the data. The intake generative model may have been established using training data defining factors for data quality, such as data integrity, consistency, accuracy, completeness, and other predefined factors (e.g., compliance policies specific to certain networks) among others. Based on the execution, the service may determine whether the aggregated data is valid. If the data is not valid, the service may also augment or modify the data, such that the data is valid (e.g., via correction or augmentation). The service may also create a data record tracing the invalid data from its origin and documenting the reason for the invalidity.

With the validation of the data, the service may generate category tags for each piece of data using the intake generative model as well as a semantic knowledge graph. The semantic knowledge graph may have been generated by the intake generative model from processing a set of dictionaries, with each dictionary being specific to different knowledge domains. The semantic knowledge graph may capture precise context information in the dictionaries, rather than statistical similarity. The service may augment the data using the semantic knowledge graph by identifying additional data (e.g., terms or tokens) to those already present in the collected data and adding the identified data to the collected data. The service may group or segment the data by category tags for storage prior to input. The groups of data may be from multiple data sources and in a format compatible for input into one of the ML models maintained by the service.

For a given group of data, the service may select an ML model from the set to apply. The selection may be based on the category tag associated with the group. For instance, the service may maintain an ML model to process application data (e.g., with application process category tags) and another ML model to process financial data (e.g., with financial transaction category tags). The task ML model may be a supervised learning model, an unsupervised learning model, or a generative model, among others. With the selection, the service may transform the data for input into one of the ML models. As part of the transformation, the service may convert the formatting of the data from the original of the data source to a formatting compatible for inputting into one the ML models. The service may feed the group of data as input into the ML model and process the data in accordance with the weights of the ML model to produce an output. In some implementations, when the selected ML model is a generative model, the service may use the generative model as an orchestration model to invoke other models to perform various tasks on the data to generate the output.

The service may generate a visualization of the output from the ML model. The service may execute an output generative model using the output ML model to generative the visualization of the output. In executing the output generative model, the service may create a prompt using a template for the type of output. The template may define the visualization of information as identified in the output from the ML model for fast and easy comprehension by the user viewing the visualization. The visualization may be in the form of a bar graph, pie chart, histogram, Venn diagram, or other graphic for presenting insights and analytics for various operations and applications in the network environment. The service may provide the prompt to the output generative model to produce the visualization of the output. With the visualizations, the user may be able quickly assess and pinpoint any problems or potential risks affecting the performance of applications or processes on servers across the network.

In this manner, the service may provide an automated data analysis to reduce the amount of time and effort spent by users in attempting to manually track down, fetch, and evaluate data. The semantic knowledge graph may be used to augment the collected data by finding additional data that have been derived as relevant from across multiple data sources. The augmentation may alleviate and address the heterogenous and fragmented nature of the data from disparate sources. The ability to carry out data quality and validation on the data using the intake generative model may improve the integrity and completeness of data. These may eliminate manual mappings or static rule coding, enabling scalable and dynamic handling of data. The resultant data may be properly and efficiently processed by ML models.

Since the data originally stored across multiple databases can be retrieved, transformed, and processed by the service to provide outputs regarding the data, any issues with applications or processes whose data is stored across these databases can now be detected. Combined with the visualization of the output, a user may be able to readily and quickly assess any such problems or risks in the network. Furthermore, the orchestration may leverage additional agents and models to carry out the task of analyzing the collected data. As such, problems or risks affecting the performance of applications or processes on servers across the network (e.g., across an enterprise) may be pinpointed and addressed. This may also improve the overall performance of the servers and client devices in the network, for instance, by reducing the computer and network resources tied up due to previously undetectable issues.

Aspects of present disclosure are directed to systems, methods, and non-transitory computer readable media for aggregating data from disparate sources to output information. A computer system may maintain a plurality of machine learning (ML) models configured for evaluating a plurality of features. The computing system may transform a first plurality of datasets of a plurality of data sources over a first time period by converting a first format of the corresponding data source for each of the first plurality of datasets to generate a second plurality of datasets in a second format of the computing system and configured for input to one of the plurality of ML models. The computing system may identify from the second plurality of datasets, a subset of datasets using a feature selected from the plurality of features for evaluation of a utility of the feature. The computing system may apply an ML model of the plurality of ML models configured for the selected feature to the subset of datasets to generate an output that measures a likelihood of usefulness. The ML model may be trained using a third plurality of datasets for the feature from the plurality of data sources over a second time period. The computing system may cause a visualization of the output for the feature to be displayed for presentation on a dashboard interface based on a template configured for the feature.

In one embodiment, the computing system may receive, via the dashboard interface, a selection of a plurality of categories for the plurality of features to be evaluated. The computing system may generate a tag identifying a category of the plurality of categories for each dataset of the second plurality of datasets. The computing system may identify the subset of datasets using the tag identifying the category of each dataset of the second plurality of datasets.

In another embodiment, the computing system may determine that more data is to be added to the subset of datasets for evaluating the utility of the feature. The computing system may retrieve a second subset of data from the second plurality of datasets to supplement the subset of datasets. In yet another embodiment, the computing system may retrieve a fourth plurality of datasets from the plurality of data sources over a third time period. The computing system may identify a subset of ML models from the plurality of ML models corresponding to a subset of features from the plurality of features present in the fourth plurality of datasets. The computing system may re-train the subset of the plurality of ML models using the fourth plurality of datasets.

In yet another embodiment, the computing system may generate from the second plurality of datasets a plurality of subsets of data corresponding to the plurality of ML models for evaluating the corresponding plurality of features. The computing system may identify the subset from the plurality of subsets based on the feature selected from the plurality of features. In yet another embodiment, the computing system may receive, via the dashboard interface, a selection of the feature from the plurality of features to be evaluated for utility. The computing system may select, from the plurality of ML models, the ML model to be applied to the subset of datasets based on the selection of the feature.

In yet another embodiment, the computing system may retrieve the first plurality of datasets from the plurality of data sources for one or more applications over the first time period. Each of the first plurality of datasets may identify at least one of a function type, a usage metric, a security risk factor, or a system criticality measure. The computing system may identify, from the second plurality of datasets transformed from the first plurality of datasets, a second subset of datasets and a third subset of datasets for evaluation of an application of the one or more applications. The computing system may train the ML model configured for evaluating the one or more applications using the second subset of dataset. The computing system may validate the ML model using the third subset of datasets.

In yet another embodiment, the computing system may apply the ML model to the subset of datasets to generate the output to identify whether the application is deprecated from use. The computing system may cause the visualization of the output for the identification of whether application is deprecated. In yet another embodiment, the computing system may maintain the plurality of ML models comprising a first subset of ML models trained in accordance with supervised learning and a second subset of ML models trained in accordance with unsupervised learning. In yet another embodiment, the computing system may identify, from a plurality of templates corresponding to the plurality of features, a template corresponding to the feature to use for generating the visualization of the output.

Aspects of the present disclosure are directed to systems and methods for aggregating data from disparate sources using generative models. One or more processors coupled with memory may retrieve, from a plurality of data sources, a first plurality of datasets for at least one of a plurality of features for a network environment over a first time period. The one or more processors may execute a first generative model using the first plurality of datasets to (i) identify one or more first datasets in the first plurality of datasets to be modified and (ii) generate one or more second datasets to substitute the one or more first datasets to create a second plurality of datasets. The one or more processors may identify, from the second plurality of datasets, at least one dataset corresponding to a feature of the plurality of features. The one or more processors may execute select, from a plurality of machine learning (ML) models, at least one ML model based on the feature, the at least one ML model trained using a third plurality of datasets for the feature from one or more of the plurality of data sources over a second time period. The one or more processors may execute the at least one ML model using the at least one dataset to determine an output including a predicted metric associated with the feature. The one or more processors may cause displaying of a visualization of the output via a graphical user interface.

In one embodiment, the one or more processors may execute a second generative model using the second plurality of datasets to generate a plurality of embeddings. Each embedding of the plurality of embeddings may include a contextual representation of at least one of the second plurality of datasets. The one or more processors may execute, using the plurality of embeddings, a clustering model comprising a plurality of clusters defined in a feature space to determine a plurality of assignments for the plurality of embeddings. Each of the plurality of assignments may identify at least one of the plurality of clusters to which a corresponding embedding of the plurality of embeddings is assigned. The one or more processors may determine, based on the plurality of assignments, the output including the predicted metric indicating a likelihood of at least one of an anomaly, a performance issue, a mitigation measure to address the performance issue, or a security vulnerability in the network environment.

In another embodiment, the one or more processors may identify, from the one or more first datasets of the first plurality of datasets, one or more token representations. The one or more processors may determine that the one or more token representations for the at least one feature corresponds to one or more of a plurality of taxonomy categories in a semantic knowledge graph. The one or more processors may generate, for each of the one or more token representations, a respective tag identifying a taxonomy category of the plurality of taxonomy categories.

In another embodiment, the one or more processors may identify, from the one or more first datasets of the first plurality of datasets, one or more token representations. The one or more processors may determine that the one or more token representations do not correspond to any of a plurality of taxonomy categories in a semantic knowledge graph. The one or more processors may create, for the semantic knowledge graph, at least one node corresponding to an additional taxonomy category to include the one or more token representations, responsive to determining that the one or more token representations do not correspond to any of the plurality of taxonomy categories. The one or more processors may modify, based on the additional taxonomy category, the one or more first datasets to generate the one or more second datasets.

In another embodiment, the one or more processors may identify a plurality of corpuses from one or more of the plurality of data sources. The one or more processors may execute the first generative model using the plurality of corpuses to (i) identify a plurality of terms across the plurality of corpuses and (ii) determine a plurality of confidence scores for the plurality of terms, each of the plurality of confidence scores indicating a degree of relevance between a corresponding pair of terms in the plurality of terms. The one or more processors may generate, using the plurality of terms and the plurality of confidence scores, a semantic knowledge graph comprising (i) a plurality of nodes corresponding to the plurality of terms and (ii) a plurality of edges, each edge of the plurality of edges defining a relationship between a corresponding pair of nodes for the corresponding pair of terms in the plurality of terms. The one or more processors may execute the first generative model and the semantic knowledge graph.

In another embodiment, the one or more processors may receive an electronic document defining one or more constraints on use of the plurality of first datasets. The one or more processors may execute a second generative model using the electronic document to generate a data structure comprising a plurality of fields and a corresponding plurality of values to define the one or more constraints. The one or more processors may store, on a database, the data structure to apply the one or more constraints. In another embodiment, the one or more processors may identify, in accordance with the one or more constraints, one or more third datasets in the first plurality of datasets to be modified. The one or more processors may generate, in accordance with the one or more constraints, one or more fourth datasets to replace the one or more third datasets in the first plurality of datasets.

In another embodiment, the one or more processors may identify, from the first plurality of datasets, at least one third dataset as not in conformance with at least one factor of a plurality of factors as defined by a data quality policy. The plurality of factors may include at least one of a data integrity factor, a data consistency factor, a data accuracy factor, a data completeness factor, or predefined factor. The one or more processors may generate a second output indicating the at least one factor as cause for identifying the at least one third dataset as not in conformance with the data quality policy.

In another embodiment, the one or more processors may determine a score indicating a likelihood that the at least one third dataset as not in conformance with the at least one factor. The one or more processors may generate the second output indicating the at least one factor as cause for identifying the at least one third dataset as not in conformance with the data quality policy, responsive to the score satisfying a threshold. The one or more processors may generate for storage on a database, a data record comprising at least one of: an indication of the at least one third dataset as not in conformance with the data quality policy, a source identifier corresponding to a data source of the plurality of data sources from which the at least one third dataset is retrieved, or the score.

In another embodiment, the one or more processors may select, from a plurality of second generative models, a second generative model based on the feature to be evaluated. The one or more processors may provide, as input to the second generative model, at least a portion of the first plurality of datasets. The one or more processors may generate, based on providing the input to the second generative model, the one or more second datasets to substitute the one or more first datasets to create the second plurality of datasets.

In another embodiment, the one or more processors may select a second generative model. The one or more processors may execute the second generative model to determine the output indicating a detecting of an anomaly in the network environment and including a report identifying one or more factors for the detection of the anomaly. In another embodiment, the one or more processors may generate a prompt using the output in accordance with a prompt template configured for the feature. The one or more processors may execute a second generative model using the prompt to generate the visualization of the output.

It is to be understood that both the foregoing general description and the following detailed description are exemplary and explanatory and are intended to provide further explanation of the embodiments described herein.

### BRIEF DESCRIPTION OF THE DRAWINGS

The accompanying drawings constitute a part of this specification, illustrate an embodiment, and together with the specification, explain the subject matter of the disclosure.

FIG. 1 depicts a block diagram of a platform for aggregating and visualizing data from disparate sources in accordance with an illustrative embodiment;

FIG. 2 depicts a block diagram of a system for aggregating data from disparate sources to output information using machine learning (ML) models in accordance with an illustrative embodiment;

FIG. 3 depicts a block diagram of a system for augmenting data aggregated from disparate sources in accordance with an illustrative embodiment;

FIG. 4 depicts a block diagram of a system for applying policies on data from disparate sources in accordance with an illustrative embodiment;

FIG. 5 depicts a block diagram of a system for training ML models using aggregated data in accordance with an illustrative embodiment;

FIG. 6 depicts a block diagram of a system for processing aggregated data using ML models in accordance with an illustrative embodiment;

FIG. 7 depicts a block diagram of a system for generating outputs from ML models in accordance with an illustrative embodiment;

FIG. 8 depicts a flow diagram of a method of aggregating data from disparate sources to output information using ML models in accordance with an illustrative embodiment;

FIGS. 9A-C depict screenshots of information on processes and application mapping presented on a dashboard interface in accordance with an illustrative embodiment;

FIGS. 10A-C depict screenshots of information characterizing applications generated presented on a dashboard interface in accordance with an illustrative embodiment;

FIGS. 11A-E depict screenshots of information of risk factors from application processes presented on a dashboard interface in accordance with an illustrative embodiment; and

FIGS. 12A-D depict a flow diagram of a use case for aggregate data related to applications and outputting information on application commission using machine learning (ML) models in accordance with an illustrative embodiment.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, as well as additional applications of the principles as illustrated here, which would occur to a person skilled in the relevant art and having possession of this disclosure, are to be considered within the scope of the disclosure.

The present disclosure is directed to systems and methods for aggregating data from multiple data sources of the network environment to output information using ML models. The server may establish and maintain a set of ML models to provide various outputs regarding the data of the environment. The service may access multiple databases to perform ingestion of the data therein over a sampling period for the applications and processes of the network environment. With the aggregation of the data, the service may transform the data to make the data compatible for input into one of the ML models. For a given group of transformed data, the service may select a ML model from the set to apply. With the selection, the service may feed the group of data as input into the ML model and process the data in accordance with the weights of the ML model to produce an output. Under runtime mode, the service may generate a visualization of the output from the ML model using a template for the type of output. The visualization may be used to present insights and analytics for various operations and applications in the network environment.

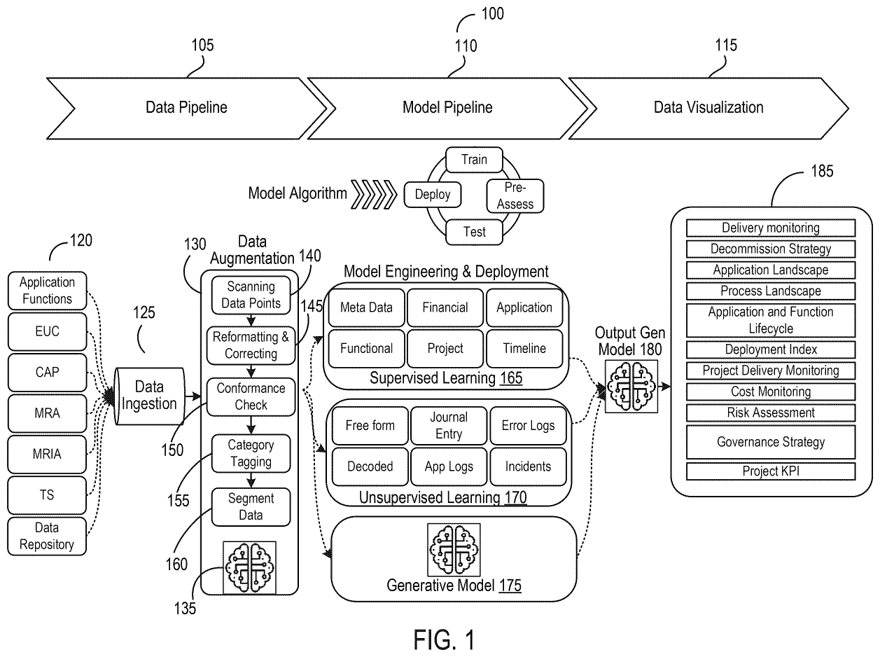

FIG. 1 depicts a block diagram of a platform 100 for aggregating and visualizing data from disparate sources. The platform 100 may carry out or include a data pipeline 105, a model pipeline 110, and a data visualization 115, among others. In the data pipeline 105, the platform 100 may access data sources for retrieval of various pieces of data 120. In the depicted example, the data may include application function, end-user computing (EUC), corrective action plan (CAP), matters requiring attention (MRA), matters requiring immediate attention (MRIA), trading service (TS), and other data repositories, among others. With the retrieval, the platform 100 may perform data ingestion 125 to store on a database maintained by the platform 100. As the data is retrieved, the platform 100 may perform a data; a data augmentation 130. In performing the data augmentation 130, the platform 100 may execute one or more generative models 135. Using the generative models 135, the platform 100 may scan data points 140, reformat and correct the data 145, check for conformance with various policies 150, generate category tags 155, and segment data based on categorization 160, among others. The generative models 135 may have been trained or fine-tuned to perform each of the tasks for data augmentation 130.

In the model pipeline 110, the platform 100 may maintain a set of ML models, including one subset of models established in accordance with supervised learning 165, another subset of models established in accordance with unsupervised learning 170, and one or more generative models 175. Based on the segment to which the data is assigned, the platform 100 may select at least one of the models to apply to the data to produce an output. With the selection, the platform 100 may input the segmented data into the selected models. For example, to detect anomalies in network data, the platform 100 may provide the segmented data as input to a generative model 175. From providing the input, the generative model 175 may output a set of embeddings that can capture various contextual information in the tokens of the input data. The platform 100 may use a clustering model, which may have been previously trained with embeddings from the generative model 175, to identify cluster assignments for the embeddings. Based on the cluster assignments, the platform 100 may determine whether there is an anomalous event in the network from the ingested data.

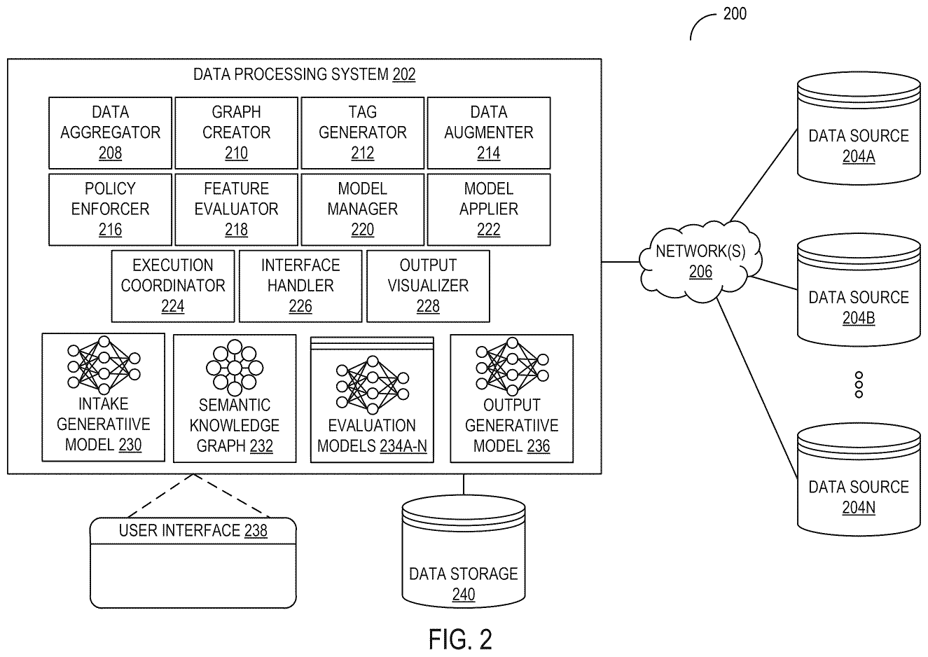

In data visualization 115, the platform 100 may use the output to generate visualizations to present on a dashboard interface. The generation of the visualization 185 may be in accordance with a template for the type of output, such as delivery monitoring, decommissioning, application landscape, process landscape, application and function lifecycle, deployment index, project delivery monitoring, cost monitoring, risk assessment, governance strategies, and project key performance indicator (KPI), among others. In some embodiments, the platform 100 may execute one or more generative models 180 using the output from the model pipeline 110 to generate the visualizations. For example, the platform 100 may create a prompt using a template prompt and the output from the model pipeline 110, and provide the prompt as input to the generative model 180. The generative model 180 may produce an output visualization on the data. The platform 100 may in turn provide the output visualization for presentation to a user device (e.g., network administrator). FIG. 2 depicts a block diagram of a system 200 for aggregating data from disparate sources to output information using ML models. The system 200 may include at least one data processing system 202 (sometimes referred herein generally as a computing system or a service) and a set of data sources 204A-N (hereinafter generally referred to data sources 204), among others, communicatively coupled with one or more networks 206. The data processing system 202 may include at least one data aggregator 208, at least one graph creator 210, at least one tag generator 212, at least one data augmenter 214, at least one policy enforcer 216, at least one feature evaluator 218, at least one model manager 220, at least one model applier 222, at least one execution coordinator 224, at least one interface handler 226, at least one output visualizer 228, at least one intake generative model 230, at least one semantic knowledge graph 232, one or more evaluation models 234A-N (hereinafter generally referred to as evaluation models 234), at least one output generative model 236, among others. The data processing system 202 may provide at least one user interface 238, among others. The data processing system 202 may include or may have accessibility to at least one data source 204.

Various hardware and software components of one or more public or private networks 206 may interconnect the various components of the system 200. Non-limiting examples of such networks may include Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols, among others.

The data processing system 202 may be any computing device comprising one or more processors coupled with memory and software and capable of performing the various processes and tasks described herein. The data processing system 202 may be in communication with the data sources 204, among others via the network 206. Although shown as a single component, the data processing system 202 may include any number of computing devices. For instance, the data aggregator 208, the graph creator 210, the tag generator 212, data augmenter 214, the policy enforcer 216, the feature evaluator 218, the model manager 220, the model applier 222, the execution coordinator 224, the interface handler 226, the output visualizer 228, the intake generative model 230, the semantic knowledge graph 232, the evaluation models 234, the output generative model 236 may be executed across one or more data processing systems 202.

The data processing system 202 may include one or more subsystems, modules, or components to executing the various processes and tasks detailed herein. Within the data processing system 202, the data aggregator 208 may retrieve data from one or more of the data sources 204. The graph creator 210 may initialize and maintain the semantic knowledge graph 232 using the data. The tag generator 212 may generate tags identifying topic categories for data using the intake generative model 230 or the semantic knowledge graph 232. The data augmenter 214 may transform and modify the data using the intake generative model 230. The policy enforcer 216 may use the intake generative model 230 to process the data retrieved from the data sources 204. The model manager 220 may train, establish, and maintain the evaluation models 234. The model applier 222 may feed and process the data using at least one of the evaluation models 234. The execution coordinator 224 may communicate with external models in processing the data via the evaluation models 234. The interface handler 226 may manage inputs and output via the user interface 238 (e.g., a graphical user interface). The output visualizer 228 may generate visualization using the output from the evaluation models 234 for presentation or display via the user interface 238. The data storage 240 may store and maintain data for use by the components of the data processing system 202.

The data processing system 202 may maintain and execute any number of machine learning models in performing various tasks. The intake generative model 230 may include any AI algorithm or machine learning (ML) model to generate output with statistical characteristics consistent with training corpuses that the model was trained on, when given the input. The intake generative model 230 may include, for example, a transformer-based deep neural network (e.g., large language model (LLM) such as a generative pre-trained transformer (GPT) or a bidirectional encoder representation from transformer (BERT)), variational autoencoder (VAE), or a generative adversarial network (GAN), among others. In general, the intake generative model 230 may include an input, outputs, and a set of weights arranged across a set of layers to relate the input and the output. The input may include a prompt (e.g., alphanumeric characters or strings) or tokens. The set of weights may be arranged or configured in accordance with the ML architecture used for the intake generative model 230. In some embodiments, the intake generative model 230 may be part of an agentic AI, invoking one or more other generative models or ML models to perform various tasks.

The semantic knowledge graph 232 may be a data structure for representing terms (or token representations of the terms) and relationship among the terms. The semantic knowledge graph 232 may include a set of nodes and a set of edges. Each node may correspond to a respective term (or corresponding token). Each edge may connect a respective pair of nodes in the semantic knowledge graph 232. Each edge may identify or indicate a semantic relationship between two terms (or tokens) corresponding to a respective pair of nodes. The semantic knowledge graph 232 may be used to unify or standardize fragmented data and differing uses of terms. The semantic knowledge graph 232 may be constructed or trained using the terms (or tokens) derived from aggregated data.

The evaluation models 234 may include any AI algorithm or machine learning (ML) model to process segmented data to generate output data. In some embodiments, at least one of the evaluation models 234 may be initialized, trained, or established in accordance with supervised learning. For example, the evaluation model 234 may be an artificial neural network (ANN), decision tree, regression model, Bayesian classifier, or support vector machine (SVM), among others. At least one of the evaluation models 234 may be initialized, trained, or established in accordance with unsupervised learning. For instance, the evaluation model 234 may be a clustering model, such as hierarchical clustering, centroid-based clustering (e.g., k-means), distribution model (e.g., multivariate distribution), or a density-based model (e.g., density-based spatial clustering of applications with noise (DBSCAN)), among others.

In some embodiments, at least one of the evaluation models 234 may include a generative model, such as a transformer-based deep neural network (e.g., large language model (LLM) such as a generative pre-trained transformer (GPT) or a bidirectional encoder representation from transformer (BERT)), variational autoencoder (VAE), or a generative adversarial network (GAN), among others, to perform a given task. In general, the output generative model 236 may include an input, outputs, and a set of weights arranged across a set of layers to relate the input and the output. The input may include a prompt (e.g., alphanumeric characters or strings) or tokens. The set of weights may be arranged or configured in accordance with the ML architecture used for the generative model. In some embodiments, the generative model may be part of an agentic AI, invoking one or more other generative models or ML models to perform various tasks.

The output generative model 236 may include any AI algorithm or machine learning (ML) model to generate output with statistical characteristics consistent with training corpuses that the model was trained on, when given the input. The output generative model 236 may include, for example, a transformer-based deep neural network (e.g., large language model (LLM) such as a generative pre-trained transformer (GPT) or a bidirectional encoder representation from transformer (BERT)), variational autoencoder (VAE), or a generative adversarial network (GAN), among others. In general, the output generative model 236 may include an input, outputs, and a set of weights arranged across a set of layers to relate the input and the output. The input may include a prompt (e.g., alphanumeric characters or strings) or tokens. The output may include visualization of outputs generated by the evaluation models 234. The set of weights may be arranged or configured in accordance with the ML architecture used for the output generative model 236. In some embodiments, the output generative model 236 may be part of an agentic AI, invoking one or more other generative models or ML models to perform various tasks.

Each data source 204 may store and maintain various datasets associated with servers, client devices, and other computing devices in a network environment (e.g., the networks 206). In some embodiments, the network environment may correspond to an enterprise network for a group of end-users including at least one data center, one or more branch offices, and remote users. The data source 204 may include a database management system (DBMS) to arrange and organize the data maintained thereon. The data on the data source 204 may be produced from a multitude of applications and processes accessible through the network environment. The applications may be an online banking application, a securities trading platform, a word processor, a spreadsheet program, a multimedia player, a video game, or a software development kit, among others. For instance, the data source 204 may store and maintain a transaction log identifying communications exchanged over the network environment, such as between end-user client devices and the servers. Upon production, the servers or end-user client devices may store and maintain the data on the data source 204. The data source 204 may store and maintain the data in accordance with its own specifications, such as formatting and contents of the data. The data maintained on the data source 204 may be accessed by the data processing system 202.

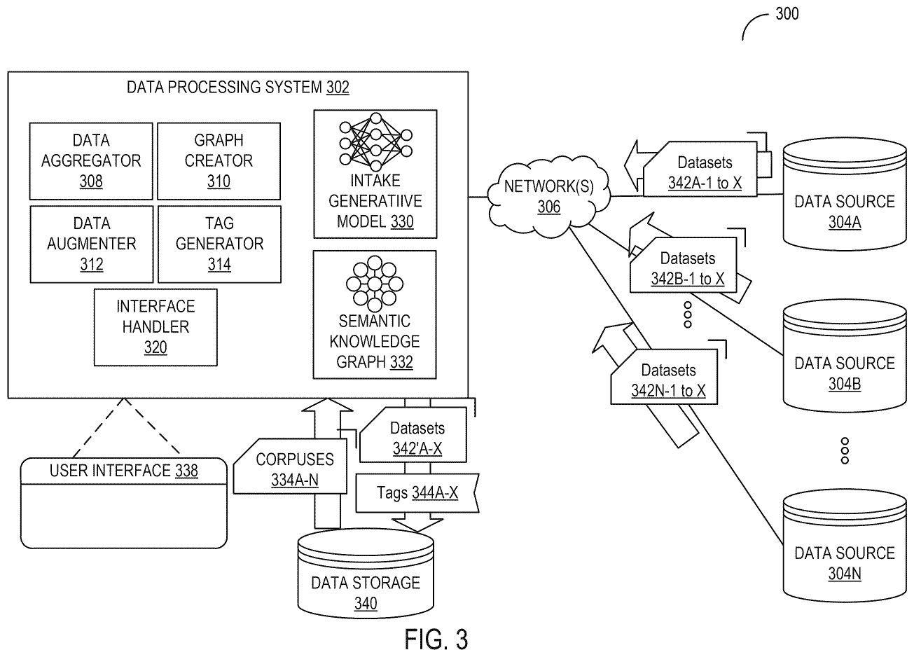

FIG. 3 depicts a block diagram of a system 300 for aggregating data from disparate sources. The system 300 may include at least one data processing system 302, one or more data sources 304A-N (hereinafter generally referred to as data sources 304), communicatively coupled with one another via at least one network 306. The data processing system 302 may include at least one data aggregator 308, at least one graph creator 310, at least one data augmenter 312, at least one tag generator 314, at least one interface handler 320, at least one data storage 340, at least one intake generative model 330, and at least one semantic knowledge graph 332, among others. The data processing system 302 may provide at least one user interface 338. Embodiments may comprise additional or alternative components or omit certain components from those of FIG. 3 and still fall within the scope of this disclosure. Various hardware and software components of one or more public or private networks 306 may interconnect the various components of the system 300. Each component in system 300 (such as the data processing system 302 and its subcomponents and the one or more data sources 304) may be any computing device comprising one or more processors coupled with memory and software and capable of performing the various processes and tasks described herein.

Each data source 304 may store and maintain one or more datasets 342A-1 to 342N-X (hereinafter generally referred to datasets 342). The data source 304 may accept, obtain, or otherwise receive the datasets 342 from one or more servers or client devices in a network environment. Each data source 304 may store and maintain the datasets 342 for one or more applications or processes accessible via the network environment. For instance, the first data source 304A may store datasets 342 related to an account balance check operation of an online banking application, whereas the second data source 304B may store datasets 342 associated with an institutional risk management platform. In another example, one or more of the data sources 304 may store and maintain datasets 342 such as a function type, a usage metric, a security risk factor, or a criticality indicator, among others.

The datasets 342 may be stored and maintained in accordance with the specification of the data source 304. The specifications may include, for example, a formatting and contents for the datasets 342. The formatting may identify, specify, or otherwise define a structure of the datasets 342 stored on the data source 304. For instance, the formatting may define a file format or database model for storing and arranging the datasets 342 in the data source 304. The contents may identify, specify, or otherwise define a type of data for the datasets 342 stored on the data source 304. For example, the specified content may define types of fields (sometimes referred herein as attribute or key) and corresponding values in the datasets 342. The specifications for the dataset 342 in one data source 304 may differ from the specifications (e.g., at least one of formatting or content type) for the dataset 342 of another data source 304. For instance, the first data source 304A may have specifications that datasets 342 are to be in the form of field-value pairs for customer relationship management, whereas the second data source 304B may have specifications that datasets 342 may be in the form of a transaction log for invocation of operations of a particular application.

The data aggregator 308 executing on the data processing system 302 may access each data source 304 to obtain, identify, or otherwise retrieve the datasets 342 from the data source 304. In some embodiments, the data aggregator 308 may accept or receive the datasets 342 sent from each data source 304. The datasets 342 retrieved by the data aggregator 308 may correspond to datasets 342 generated or stored by the data source 304 over a period of time. The period of time may correspond to a sampling window over which the datasets 342 were generated at each data source 304. The period of time may span any amount of time, for example, from 5 minutes to 2 months since the previous retrieval of the datasets 342 from the data sources 304. In some embodiments, the data aggregator 308 may instruct, command, or otherwise request the datasets 342 from each data source 304 for the specified period of time. With the retrieval, the data aggregator 308 may store and maintain the datasets 342 retrieved from the data sources 304 in the data storage 340 in the original specifications for the datasets 342. The data aggregator 308 may also perform initial scanning of the datasets 342 retrieved from the data sources 304.

In conjunction, the graph creator 310 executing on the data processing system 302 may create or generate the semantic knowledge graph 332 using data from the data sources 304. To create, the graph creator 310 may retrieve, obtain, or otherwise identify a set of corpuses 334A-N (hereinafter generally referred to as corpuses 334). In some embodiments, the corpuses 334 may be from the one or more data sources 304. In some embodiments, the corpuses 334 may correspond to the datasets 342. In some embodiments, the corpuses 334 may be stored and maintained on the data store 340. Each corpus 334 may include a respective set of terms from at least one of the data sources 304. For example, one corpus 334 may include document containing a series of words or phrases with diction (e.g., terminology) specific to a given data source 304. In some embodiments, the corpus 334 may be unstructured (e.g., free-text) or structured (e.g., using field-value pairs). For example, one corpus 334 may include a structured data object with field-value pair for an activity log for an application. The corpuses 334 may be general domain (e.g., general to multiple applications or features) or specific to a particular domain (e.g., for a particular application, function, or feature). In some embodiments, the corpus 334 may include a respective dictionary of terms for one or more data sources 304.

With the identification of the corpuses 334, the graph creator 310 may apply or execute the intake generative model 330 using set of corpuses 334. Based on the execution of the intake generative model 330, the graph creator 310 may extract or identify the set of terms across the set of corpuses 334 for the data sources 304. In some embodiments, the set of terms extracted from the corpuses 334 may include unique words or phrases. In some embodiments, the set of terms extracted from the corpuses 334 may include key words or key phrases (e.g., based on entity, frequency, contextual prominence, or domain relevance). In addition, from executing the intake generative model 330, the graph creator 310 may calculate or determine a set of confidence scores among the set of terms. Each confidence score may identify or indicate a degree of relevance (e.g., semantic distance) between a corresponding pair of terms in the plurality of terms.

For example, the intake generative model 330 may analyze the definitions, descriptions, and usage examples within and across data dictionaries (e.g., the corpuses 334). If the definition of a term in Dictionary A semantically relates to a term in Dictionary B (e.g., “User ID” in one dictionary and “Unique Identifier for a Client” in another), the intake generative model 330 may infer a potential owl:sameAs or skos:exactMatch relationship. The intake generative model 330 may leverage vast pre-training knowledge to determine relationships among synonyms, related concepts, and domain-specific jargon, among others. The intake generative model 330 can also be fine-tuned to recognize structural patterns. For instance, if Dictionary A describes “Transaction” with attributes “user_id”, “transaction_id”, and “transaction_date”, and Dictionary B describes “client_transaction” with “user_identifier”, “item_code”, and “transaction_time”, GenAI can infer that “Transaction” and “Client_Purchase” are likely owl:equivalentClass due to the semantic similarity of their associated attributes, even if the names are different. The intake generative model 330 can use its general and domain-specific knowledge to suggest connections. If it sees “Bank Account” and “User” in the same context frequently, it can infer a potential hasAccount or other relationship.

Using the terms identified from the corpuses 334 and the set of confidence scores, the graph creator 310 may construct, produce, or otherwise generate the semantic knowledge graph 332. The semantic knowledge graph 332 may capture the semantic context and relevance among the terms identified from the data sources 304. The semantic knowledge graph 332 may include a set of nodes and a set of edges. Each node may correspond to or represent a respective term or phrase (or a respective token representation). Each edge may connect a respective pair of nodes in the semantic knowledge graph 332. Each edge may identify or indicate a semantic relationship between a respective pair of terms corresponding to a respective pair of nodes in the semantic knowledge graph 332. Each edge may include the corresponding confidence score determined for the pair of terms.

In some embodiments, the graph creator 310 may generate the set of nodes corresponding to the set of extracted terms for the semantic knowledge graph 332. The graph creator 310 may traverse through the set of confidence scores for corresponding pairs of terms. For each confidences core, the graph creator 310 may compare the confidence score with a threshold. If the confidence score satisfies (e.g., greater than or equal to) the threshold, the graph creator 310 may include or add a respective edge between the pair of nodes for the respective pair of terms in the semantic knowledge graph 332. Otherwise, if the confidence score does not satisfy (e.g., less than) the threshold, the graph creator 310 may refrain from adding the edge between the pair of nodes for the respective pair of terms. One or more terms in a subset of nodes of the semantic knowledge graph 332 may correspond to a respective taxonomy category.

In generating the semantic knowledge graph 332, the graph creator 310 may also perform predicate selection. For example, once a potential edge is inferred, the graph creator 310 may refine the edge by selecting the most appropriate and specific semantic predicate. Instead of a generic “relatedTo,” the graph creator 310 in conjunction with the intake generative model 330 can narrow it to hasUser, isAssociatedWith, references, isMemberOf, hasLifecycleStage, isDerivedFrom, or isOwnerOf based on the nuances in the definitions. The graph creator 310 may also perform contextual disambiguation. Data dictionaries may use the same term with different meanings (e.g., “Account” for a bank account versus a user account). Using intake generative model 330, the graph creator 310 may process the surrounding context (other terms, data types, examples) to disambiguate and select the correct relationship. For instance, an “Account” linked to “Balance” and “Transaction” would imply a financial account, while an “Account” linked to “Username” and “Password” would imply a user account. In some embodiments, the graph creator 310 may carry out constraint and rule applications. The intake generative model 330 can be guided by or fine-tuned with ontological constraints (e.g., “a person cannot be a subClassOf an organization”). The graph creator 310 in conjunction with the intake generative model 330 can narrow relationships by checking for logical consistency and adherence to predefined ontological rules, ensuring the generated graph is semantically sound. The graph creator 310 may use the confidence scores assigned by the intake generative model 330 to inferred and narrowed edges.

With the retrieval, the data augmenter 312 executing on the data processing system 302 may apply or execute the intake generative model 330 using the one or more datasets 342 to perform data correction, modification, or augmentation. From executing the intake generative model 330, the data augmenter 312 may select or identify one or more datasets 342 from the set of datasets 342 to be modified. The selection may be based on any number of factors. For example, the data augmenter 312 may identify the one or more datasets 342 that include missing or incomplete data. Different applications may use the same logical functions (e.g., “user authentication” or “transaction processing”) using inconsistent terminology in code, logs, and documentation. This fragmentation may hinder effective data ingestion and analysis for ML models used in vulnerability detection or operational insights. The intake generative model 330 may be fed with data from application codebases, API documentation, system logs, and internal data, among others.

With the identification of the one or more datasets 342, the data augmenter 312 may create, produce, or otherwise generate one or more new datasets 342′A-X (hereinafter generally referred to as dataset 342′) using the intake generative model 330. The intake generative model 330 can generate and provide missing contextual information. For example, based on providing the one or more datasets 342, the data augmenter 312 may estimate a likely risk level for an application based on its dependencies, age, and observed performance anomalies, drawing from its training dataset identifying common vulnerabilities. In another example, the intake generative model 330 may be provided with the datasets 342, extracting all references to application functions, and may identify semantic equivalences (e.g., “login,” “sign-in,” “user verification” are all “User Authentication”) and normalizes the different terms under a single, canonical term to include in the new datasets 342′. The one or more new datasets 342′ may replace or substitute the one or more datasets 342. With the generation of the new datasets 342′, the data augmenter 312 may store and maintain the new datasets 342′ along with the remaining datasets 342 on the data storage 340.

In some embodiments, the data augmenter 312 may execute one or more external generative models to generate the datasets 342′ corresponding to the one or more datasets 342. The external generative models may be hosted or executed on services, separate from the data processing system 302. The external generative models may be a generative model, such as generative pre-trained transformer (GPT), bidirectional encoder representations from transformers (BERT), or recurrent neural network (RNN), among others. In some embodiments, at least one external generative model may have been trained using domain-specific training data (e.g., for a particular application, function, or feature). The external generative models may be executed in concert or orchestration with the intake generative model 330. The external generative model may facilitate the intake generative model 330 in carrying out data correction, modification, or augmentation, for a particular feature.

In executing the intake generative model 330, the data augmenter 312 may select or identify at least one of the external generative models. The selection may be performed by the intake generative model 330 based on any number of factors or the feature (e.g., application or function) to be evaluated. With the selection, the data augmenter 312 may provide at least a portion of the datasets 342 (or the one or more datasets 342) to the external generative model. The external generative model may select or identify the one or more datasets 342 from the set of datasets 342 for data correction, modification, or augmentation. Based on providing the input to the intake generative model 330, the data augmenter 312 may generate the one or more new datasets 342′ to replace or substitute the one or more datasets 342 in the overall set of datasets 342. With the generation of the new datasets 342′, the data augmenter 312 may store and maintain the new datasets 342′ along with the remaining datasets 342 on the data storage 340.

In some embodiments, the data augmenter 312 may perform one or more transformations on the datasets 342. When received, the datasets 342 may initially be in the original specifications (e.g., formatting and content type) of the data source 304. For each dataset 342, the data augmenter 312 may change, modify, or otherwise convert the format of the dataset 342 from the original format to at least one format of the data processing system 302 to generate a corresponding new dataset 342′. In some embodiments, the data augmenter 312 may generate the new dataset 342′ using multiple datasets 342 from one or more data sources 304. The format for the new dataset 342′ may be for entry, feeding, or input to one of the evaluation models of the data processing system 302. The format for the new dataset 342′ may differ from the original format of the dataset 342. In some embodiments, the data augmenter 312 may select or identify the format from a set of formats to convert to based on any number of factors, such as the data source 304 or the contents of the original datasets 342, among others. For example, the data augmenter 312 may identify the data source 304 as associated with application log data, and may select the format for processing the application log data at the data processing system 302.

Continuing on, the data augmenter 312 may perform data correction on the datasets 342′ (or datasets 342). With the conversion, the dataset 342′ may include one or more fields for which there are no values from the original corresponding dataset 342. For each dataset 342′, the data augmenter 312 may identify or determine whether more data is to be added to the dataset 342′. If there are no missing values in the dataset 342′, the data augmenter 312 may determine that no supplemental data is to be added to the dataset 342′. With the determination, the data augmenter 312 may maintain the dataset 342′ as is. On the contrary, if there is any portion of the dataset 342′ with missing values, the data augmenter 312 may determine that more data is to be added to the dataset 342′. The data augmenter 312 may continue to traverse through the datasets 342′ to determine whether more data is to be added.

With the determination that more data is to be added, the data augmenter 312 may generate, identify, or retrieve supplemental data to add to the dataset 342′. In some embodiments, the data augmenter 312 may identify associated datasets 342′ for the supplemental data. For example, the dataset 342′ with the missing values may be associated with a particular application. In this case, the data augmenter 312 may retrieve or identify other datasets 342′ also associated with the application to retrieve the supplemental data. With the retrieval, the data augmenter 312 may add the supplemental data to the dataset 342′. In some embodiments, the data augmenter 312 may determine or generate the supplemental data using other values in the dataset 342′. For example, the dataset 342′ may have missing values for fields that can be derived from values of other fields in the same dataset 342′. Based on the other values, the data augmenter 312 may generate the supplemental data to insert into the dataset 342′. In some embodiments, the data augmenter 312 may access or search a knowledge base for the supplemental data to add to the dataset 342′. The knowledge base may be constructed using information from the network environment (e.g., the enterprise network) besides the data sources 304, and may include information about the network environment.

The tag generator 314 executing on the data processing system 302 may determine or generate at least one tag 344A-X (hereinafter generally referred to tag 344) for each dataset 342′ (or dataset 342). The tag 344 may define or identify a topic category of the associated dataset 342′. The topic categories may include, for example, delivery monitoring, decommissioning, application landscape, process landscape, application and function lifecycle, deployment index, project delivery monitoring, cost monitoring, risk assessment, governance strategies, and project key performance indicator (KPI), among others. The topic categories may correspond to features to be evaluated using one or more ML models for outputting information on the datasets 342′. The tag 344 may be generated and maintained using one or more data structures, such as an array, a linked list, a tree, a heap, or a matrix, among others.

In some embodiments, to identify the topic category, the tag generator 314 may process or parse the fields or values within the dataset 342′ using natural language processing (NLP) algorithms, such as automated summarization, text classification, or information extraction, among others. In some embodiments, the tag generator 314 may generate the tag 344 based on the data source 304 from which the dataset 342 is retrieved. For example, the tag generator 314 may identify the topic category for the dataset 342′ as for application-related metrics based on an identification of the data source 304 as storing data for one or more applications in the network environment. With the identification, the tag generator 314 may generate the tag 344 to identify the topic category for the dataset 342′.

In some embodiments, the tag generator 314 may identify or select the topic category from a set of candidate topic categories for the datasets 342′ retrieved from the data sources 304. The tag generator 314 in conjunction with the interface handler 320 may retrieve, identify, or otherwise receive the set of candidate topic categories via the user interface 338. The interface handler 320 may provide the user interface 338 for presentation on a display coupled with the data processing system 302 or a computing device (e.g., administrator's computing device) in communication with the data processing system 302. The user interface 338 may include one or more user interface elements for defining the candidate topic categories. Upon entry or input via the user interface 338 (e.g., by the user), the interface handler 320 may retrieve or identify the definitions for the topic categories.

With the definitions, the tag generator 314 may compare with the fields and values of each dataset 342′ (or dataset 342) with the set of candidate topic categories. The comparison may be facilitated using NLP techniques as discussed above. Based on the comparison, the tag generator 314 may identify or select the topic category to use as the tag 344 for the dataset 342′. For instance, the tag generator 314 may use a knowledge graph to compare the topic category derived from the dataset 342′ with the candidate topic categories to calculate a semantic distance. The tag generator 314 may select the candidate topic category with the closest semantic distance with the derived topic category to use for the tag 344 for the dataset 342′. In some embodiments, the tag generator 314 may generate or generate a segment corresponding to a group of datasets 342′. The segment may be defined using the common topic category identified in the tags 344 of the subset of datasets 342′.

In some embodiments, tag generator 314 may execute the intake generative model 330 and the semantic knowledge graph 332 to generate the tags 344 for the corresponding set of datasets 342 (and datasets 342′). The intake generative model 330 together with the semantic knowledge graph 332 may be used to automatically identify nuanced topic categories, sub-categories, and cross-cutting concerns by understanding the semantic content of the data, rather than just relying on keyword matching or pre-defined patterns. The semantic knowledge graph 332 along with the intake generative model 330 may be used to perform a tagging mechanism. For example, when log entries or metrics arrive, the intake generative model 330 and the semantic knowledge graph 332 may be provided with the data and may process their content and context to accurately and consistently tag the new data with the standardized terms from the taxonomy. The addition of these tags may increase the compatibility of the ingested data with uniform tags, for cross-application analysis, vulnerability detection, and broader operational insights.

In executing, the tag generator 314 may generate or identify one or more token representations from the datasets 342 (or the one or more datasets 342 identified from the overall set of received datasets 342). Each token representation may correspond to a term or a phrase within a corresponding dataset 342. The token representations may be, for example, a numeric representation of the corresponding term or phrase with the dataset 342 generated from a tokenization layer of the intake generative model 330. In some embodiments, the tag generator 314 may generate the tags 344 for each dataset 342. With the identification of token representations, the tag generator 314 may check or determine whether the token representations correspond to the taxonomy categories in the sematic knowledge graph 332. Correspondence between token representations with the taxonomy categories may be associated with a semantic distance as defined by at least one edge in the semantic knowledge graph 332. For there to be correspondence, the semantic distance between a node with the token representation and a node with terms of the taxonomy category in the semantic knowledge graph 332 may be with (e.g., less than) a threshold distance. The semantic distance may be determined using the edges of the semantic knowledge graph 332 or using the intake generative model 330.

If the token representation corresponds to or matches at least one of the nodes in the sematic knowledge graph 332, the tag generator 314 may determine that the token representations correspond to one or more of the taxonomy categories defined in the sematic knowledge graph 332. For the datasets 342, the tag generator 314 may create or generate the tag 344 identifying the taxonomy categories. With the creation, the tag generator 314 may modify the datasets 342 to include or add the tags 344 (to form the corresponding datasets 342′). In some embodiments, the tag generator 314 may iteratively add the tags 344 to modify the datasets 342. For each dataset 342, the tag generator 314 may create or generate the respective tag 344.

On the other hand, if the token representation does not correspond to or does not match any of the nodes in the sematic knowledge graph 332, the tag generator 314 may determine that the token representations do not correspond or match to any of the taxonomy categories defined in the sematic knowledge graph 332. In some embodiments, the tag generator 314 may determine that there is no correspondence based on the semantic distance as generated by the intake generative model 330 between the token representation and the terms in the nodes of the semantic knowledge graph 332. With this determination, the tag generator 314 may instantiate, generate, or otherwise create at least node corresponding to a new, additional taxonomy category to include the token representations. The node may include or identify terms (or token representations) that are determined to not correspond or match other terms in the nodes of the sematic knowledge graph 332. The tag generator 314 may also generate or create at least one edge between the newly created node at least one other node (e.g., with the closest semantic distance) of the sematic knowledge graph 332. The tag generator 314 may add the new node and edge to the semantic knowledge graph 332. In addition, the tag generator 314 may modify the datasets 342 to include or add the tags 344 with the new taxonomy category (to form the corresponding datasets 342′).

Upon generation, the tag generator 314 may store and maintain the tags 344 along with the datasets 342′ on the data storage 340. In some embodiments, the tag generator 314 may insert or add the tags 344 to the datasets 342′. For instance, the tag generator 314 may add the tag 344 as a field-value pair along with other field-value pairs of the associated dataset 342′. In some embodiments, the tag generator 314 may determine or generate at least one association between the tag 344 and the corresponding dataset 342′ from which the tag 344 was generated. The tag generator 314 may store the association on the data storage 328. In some embodiments, the tag generator 314 may store the segment corresponding to group of datasets 342′ defined using the common topic category of tags 344 of each dataset 342′ in the group. The tag generator 314 may store and maintain an association between the segment of the datasets 342′ with the tag 344 on the data storage 340.

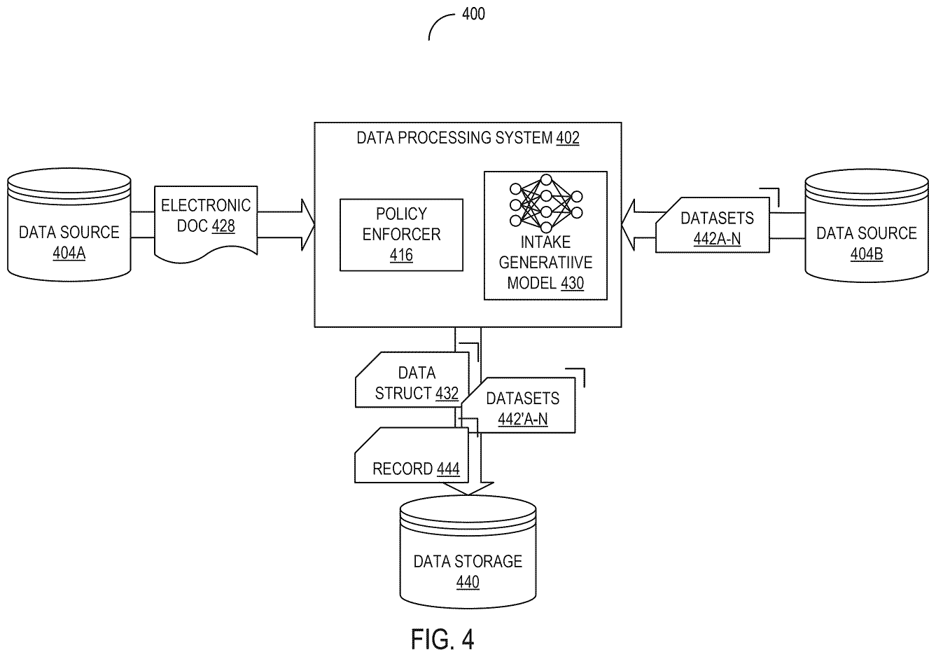

FIG. 4 depicts a block diagram of a system 400 for applying policies on data from disparate sources. The system 400 may include at least one data processing system 402, one or more data sources 404A and 404B (hereinafter generally referred to as data sources 404), and at least one data storage 440, communicatively coupled with one another via at least one network. The data processing system 402 may include at least one data policy enforcer 416, and at least one intake generative model 430, among others. Embodiments may comprise additional or alternative components or omit certain components from those of FIG. 4 and still fall within the scope of this disclosure. Various hardware and software components of one or more public or private networks may interconnect the various components of the system 400. Each component in system 400 (such as the data processing system 402 and its subcomponents) may be any computing device comprising one or more processors coupled with memory and software and capable of performing the various processes and tasks described herein.

The policy enforcer 416 executing on the data processing system 402 may retrieve, obtain, or otherwise receive at least one electronic document 428. The electronic document 428 may be received from at least one data source 404 (e.g., the data source 404A as depicted). The electronic document 428 may identify or define one or more constraints on the use of datasets from one of data sources 404 in the network. The electronic document 428 may include specifications on a policy for the constraint to transfer, modify, or otherwise use the datasets 442 within a given network. The policy may include, for example, a data ingestion policy (DIP) from a regulatory agency (e.g., in the form of a legal text), a company or organization policy (e.g., in the form of a handbook), or an administrator, among others. The constraints may specify, for example, modification or removal of personally identifiable information (PII); restriction of transfer or use in creating outputs; time limit in which the data is permitted to be used; or conditions for data erasure, among others. The electronic document 428 may include unstructured free text and content defining the constraints to be applied to the data. In some embodiments, the constraints defined by the electronic document 428 may be particular to a given data source 404. In some embodiments, the constraints defined by the electronic document 428 may be particular to a geographic region in which the data originates.

The policy enforcer 416 may apply or execute the intake generative model 430 using the electronic document 428 to generate at least one data structure 432. In executing, the policy enforcer 416 may create a prompt to direct the intake generative model 430 to generate a machine-interpretable instructions from the definition of the constraints in the electronic document 428. The policy enforcer 416 may provide the prompt as input to the intake generative model 430. The intake generative model 430 may semantically analyze the input to identify explicit and implicit constraints and translate the electronic document 428 into the data structure 432. The data structure 432 may include a set of fields and a set of values corresponding to the constraints. The data structure 432 may be machine-readable instructions for applying the constraints to the data in the environment. The data structure 432 may be for example, in a JavaScript Object Notation (JSON), extensible markup language (XML), or YAML format, among others. For instance, the data structure 432 may define a data ingestion policy in YAML format:
apiVersion: data.example.com/v1alpha1
kind: DataIngestionPolicy
metadata:
   name: gdpr-data-minimization-analytics
spec:
   target:
      dataset: “transaction_logs”
      processingPurpose: “fraud_detection”
   actions:
      type: “pseudonymize_field”
      field: “user_name”
      algorithm: “SHA256_HASH”
      type: “reject_field”
      field: “user_address”
      reason: “Not required for fraud detection.”
audit: “high”
   With the generation, the policy enforcer 416 may store and maintain the data structure 432 on the storage 440. In some embodiments, the policy enforcer 416 may train or fine-tune the intake generative model 430 to apply the one or more constraints as defined in the electronic document 428 to data in the network.

Using the data structure 432, the policy enforcer 416 may apply the constraints on datasets 442A-N (herein referred to as datasets 442) received from one or more data sources 404 (e.g., the data source 404B as depicted). Based on the data source 404 of origin, the policy enforcer 416 may select or identify the data structure 432 applicable to the datasets 442. In accordance with the constraints defined in the data structure 432, the policy enforcer 416 may select or identify one or more datasets 442 from the overall set of data sets 442 to be modified. For example, if the constraints specify that PII or sensitive information is to be removed, the policy enforcer 416 may select datasets 442 that contain such information for modification. With the identification, the policy enforcer 416 may create or generate one or more new datasets 442′A-X (hereinafter generally referred to as dataset 442′) corresponding to the identified datasets 442. For each identified dataset 442, the policy enforcer 416 may modify the dataset 442 in accordance with the constraints as defined in the data structure 432 to yield or generate the modified dataset 442′. For instance, the policy enforcer 416 may modify the dataset 442 to obfuscate or remove the PII in the contents of the dataset 442. The modified datasets 442′ may substitute or replace the identified datasets 442. The policy enforcer 416 may store and maintain the modified datasets 442′ (along with the remaining datasets 442) on the storage 440.

In one use case, the policy enforcer 416 may process incoming datasets, along with their intended processingPurpose and dataSubjectId fields, in accordance with the data structure 432 (e.g., in YAML format). The policy enforcer 416 may identify the relevant data ingestion policy corresponding to the data structure 432. The policy enforcer 416 may query a Consent Dataset using the dataSubjectId and processingPurpose to verify explicit consent or “right to erasure” status. Based on the DIPL rules and consent status, the policy enforcer 416 may execute specific actions (e.g., pseudonymize_field, reject_field, reject_record). The policy enforcer 416 may execute these actions on the incoming data before the datasets enter the data storage 440, ensuring compliance from the earliest point. In this manner, only compliant, appropriately processed data may be ingested, with a full audit trail of policy decisions and actions for traceability.

In some embodiments, the policy enforcer 416 executing on the data processing system 402 may apply or execute the intake generative model 430 to modify the datasets 442 in accordance with at least one data quality policy. In some embodiments, the intake generative model 430 may be trained or fine-tuned to apply a data quality policy (e.g., using documentation similar to the electronic document 428) on incoming data prior to storage on the data storage 440. The training or fine-tuning may be in accordance with such techniques for large language models or generative models. In some embodiments, the intake generative model 430 may be provided with a prompt including the data quality policy along with the datasets 442 to check for compliance with the policy. The data quality policy may specify or define one or more factors under which datasets are to be identified for lack of quality or for violation, and restricted from storage on the data storage 440. The factors may include one or more of: a data integrity factor, a data consistency factor, a data accuracy factor, a data completeness factor, or predefined factor, among others.

The data integrity factor may identify violations for type mismatches (e.g., values not conforming to column data types such as text in a numeric field), format inconsistencies (e.g., dates, identifiers, or codes not adhering to specified patterns or inconsistent date formats), or constraint violations (e.g., breaches of primary or foreign key relationships or unique constraints), among others. The data consistency factor may define cross-table discrepancies (e.g., inconsistent values for related entities across different tables, such as a user_status in users table differs from user_activity_status in transactions table for the same user), and temporal inconsistencies (e.g., logical sequence errors in time-series data such as with start_date after end_date), among others. The data accuracy factor may identify violations for out-of-range or invalid values (e.g., values falling outside expected ranges, such as negative ages, transaction amounts exceeding plausible limits, unknown currencies), missing mandatory data (e.g., nulls in non-nullable fields or critical information gaps), or semantic drift (e.g., values or patterns that deviate from expected real-world meaning based on context, such as a country column containing unexpected abbreviations), among others. The predefined factor may include other specifications, such as data not adhering to complex logic (e.g., “a user must have at least 5 transactions per month”).

The intake generative model 430 may be used to evaluate or identify the datasets 442 as compliant or non-complaint with data quality policies. For example, the intake generative model 430 may ingest and understand table definitions, column descriptions, data types, constraints (from data dictionaries or DDL), and sample data. They form an implicit model of the database's intended structure and meaning. The intake generative model 430 may identify outliers in distributions or anomalies from the overall context. For example, the intake generative model 430 may infer that user_status=‘pending’ should always be paired with transaction_date IS NULL for new transactions, and flag deviations. The intake generative model 430, having been trained on general knowledge and fine-tuning on domain-specific data, can detect semantic inconsistencies. The intake generative model 430 can generate outputs about potential data quality rules from database samples and validate them against broader datasets. The intake generative model 430 may also generate output in natural language form to indicate the cause for why a dataset is flagged as potentially failing, linking the data back to inferred rules or schema descriptions.

The intake generative model 430 may carry out database data quality checks to streamline data governance for the network. The intake generative model 430 may augment data profiling tools by providing semantic insights. For instance, the intake generative model 430 may process data to generate an output indicating that “20% of ‘user_email’ fields are null, which violates the Opt-in’ rule derived from guidelines. Using the intake generative model 430, database tables, specific rows, or entire columns with high predicted failure scores may be prioritized to flag to system administrator. The output with explanations generated by the intake generative model 430 may provide immediate context for the suspected issue, accelerating investigation. In some embodiments, the intake generative model 430 may generate outputs to suggest potential SQL queries to clean, transform, or correct data (e.g., UPDATE table SET column=default WHERE column IS NULL, or SELECT*FROM table WHERE condition_violates_rule). The intake generative model 430 may generate documentation for identified data quality issues, including the rule violated, affected data, and potential impact, for auditability and compliance. In addition, human validation of the outputs by the intake generative model 430 may fed back to fine-tune the intake generative model 430, continuously improving its accuracy in data quality prediction and rule inference over time.

Based on executing the intake generative model 430, the policy enforcer 416 may select or identify one or more datasets 442 from the set of datasets 442 received from the data sources 404 not in compliance with at least one of the factors of the data quality policy. The execution of the intake generative model 430 may be performed in at least partial conjunction (e.g., serially or in parallel) with the application of the constraints as defined by the data structure 432. For each identified dataset 442, the policy enforcer 416 may identify or determine one or more factors that the dataset 442 does not comply with (e.g., from the output of the intake generative model 430). With the determination, the policy enforcer 416 may create or generate at least one output indicating the one or more factors as the cause for identifying the dataset 442 as not in conformance with the data quality policy. Conversely, the policy enforcer 416 may identify other datasets 442 from the set of datasets 442 received from the data sources 404 in compliance with all the factors of the data quality policy. The policy enforcer 416 may generate at least one output indicating that the identified datasets 442 are in conformance with the data quality policy.

In some embodiments, using the intake generative model 430, the policy enforcer 416 may calculate or determine a respective score indicating a likelihood of each dataset 442 as not in conformance (or in conformance) with at least one of the factors of the data quality policy. For instance, as part of the prompt input, the policy enforcer 416 may direct the intake generative model 430 to provide the score for each dataset 442. For each dataset 442, the policy enforcer 416 may compare the score with a threshold delineating whether a value at which the dataset 442 is to be identified as not in compliance with the factor of the data quality policy. If the score does not satisfy (e.g., less than) the threshold, the policy enforcer 416 may identify the dataset 442 as in compliance with the corresponding factor. If the score satisfies (e.g., greater than or equal to) the threshold, the policy enforcer 416 may identify the dataset 442 as not in compliance with the corresponding factor. The policy enforcer 416 may create or generate the output indicating the factor as the cause for identifying the dataset 442 as not in conformance with the data quality policy.

When the dataset 442 is identified as not in compliance with at least one of the factors, the policy enforcer 416 may create or generate at least one data record 444. The data record 444 may identify or include one or more of: an indication of the dataset 442 as not in conformance with the data quality policy, a source identifier corresponding to the data source 404 (e.g., the data source 404B) from which the dataset 442 is retrieved, or the score for each factor, among others. With the creation of the data record 444, the policy enforcer 416 may store and maintain the data record 444 on the data storage 440. The data record 444 may be used to trace datasets 442 that are not compliant with the data quality policy.

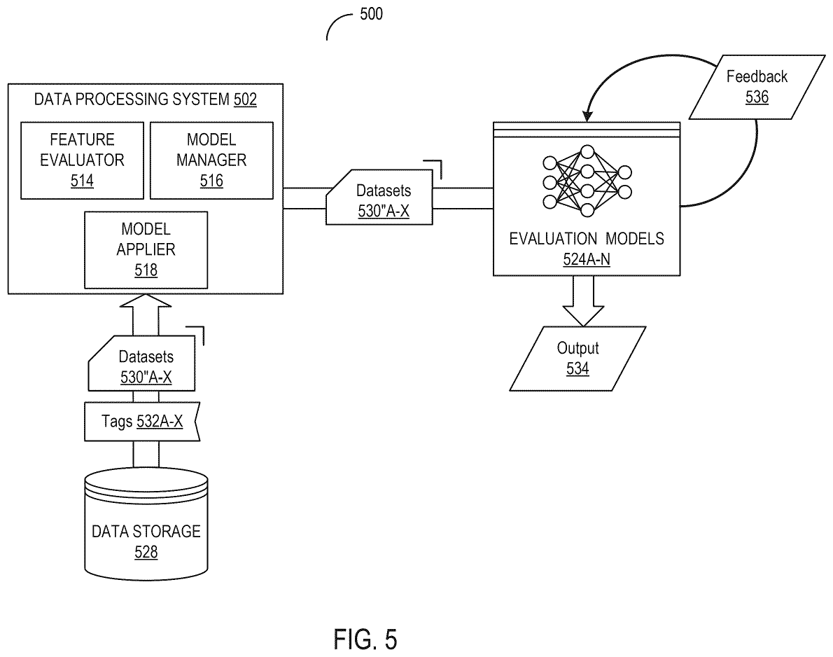

FIG. 5 depicts a block diagram of a system 500 for training ML models using aggregated data. The system 500 may include at least one data processing system 502. The data processing system 502 may include at least one feature evaluator 514, at least one model manager 516, at least one model applier 518, one or more evaluation models 524A-N (hereinafter generally referred to as evaluation models 524), and at least one data storage 528, among others. In the system 500, the data processing system 502 and its components may be in a training or learning mode to train at least one of the evaluation models 524. Embodiments may comprise additional or alternative components or omit certain components from those of FIG. 5 and still fall within the scope of this disclosure. Various hardware and software components of one or more public or private networks may interconnect the various components of the system 500. Each component in system 500 (such as the data processing system 502 and its subcomponents) may be any computing device comprising one or more processors coupled with memory and software and capable of performing the various processes and tasks described herein.

The feature evaluator 514 executing on the data processing system 502 may identify or select a subset of datasets 530″A-X (hereinafter generally referred to as datasets 530″) using at least one feature for evaluation using at least one of the evaluation models 524. The feature may correspond to at least one topic category for the datasets 530″ to be evaluated or analyzed for at least one metric, such as utility, risk level, performance, health, among others. The utility may indicate a degree of usefulness of the feature evaluated. The risk level may correspond to a degree of vulnerabilities or susceptibility to lapses (e.g., security, downtime, failure, or breakdown) from the feature assessed. The performance may be a metric indicating proper functioning of components of the feature evaluated. The health may correspond to a condition of the features evaluated. The subset of datasets 530″ may be obtained, received, or otherwise retrieved from over a period of time. The period of time may correspond to a sampling window over which the datasets were generated at each data source. The datasets 530″ may be converted into the format compatible for inputting into the evaluation model 524.

In some embodiments, the feature evaluator 514 may select or identify the subset of datasets 530″ using the at least one tag 532. The tag 532 may identify the topic category for each associated dataset 530″. The topic category defined by the tag 532 may correspond to the feature to be evaluated for the metric (e.g., utility or risk level). The feature evaluator 514 may traverse through the set of possible topic categories identified across the tags 532 of the data storage 528 to identify corresponding subsets of datasets 530″. In some embodiments, the feature evaluator 514 may identify the subset of datasets 530″ using the corresponding period of time to be evaluated for the network environment. In some embodiments, the feature evaluator 514 may produce or generate a segment corresponding to the subset of datasets 530″. The segment may be defined using the feature or by extension the common topic category identified in the tags 532 of the subset of datasets 530″. In some embodiments, the feature evaluator 514 may identify the segment corresponding to the subset of datasets 530″ (e.g., previously defined by the tag generator) stored on the data storage 528.

In conjunction, the model manager 516 executing on the data processing system 502 may initialize, establish, and maintain the set of evaluation models 524. The set of evaluation models 524 may be for evaluating or analyzing the corresponding set of features. Each evaluation model 524 may correspond to at least one of the topic categories present in the tags 532 of the datasets 530″. Each evaluation model 524 may be dedicated or otherwise configured to process datasets 530″ of the feature and by extension the associated topic category of the tag 532. In general, each evaluation model 524 may have: at least one input corresponding to the subset of datasets 530″, at least one output from processing the input, and a set of parameters (e.g., weights) to process the inputs to generate the output. To train the evaluation model 524, the model manager 516 may invoke the model applier 518 to apply the identified datasets 530″.

At least one of the evaluation models 524 may be initialized, trained, or established in accordance with supervised learning. For example, the evaluation model 524 may be an artificial neural network (ANN), decision tree, regression model, Bayesian classifier, or support vector machine (SVM), among others. In some embodiments, the evaluation model 524 may be a generative model, such as generative pre-trained transformer (GPT), bidirectional encoder representations from transformers (BERT), or recurrent neural network (RNN), among others. At least one of the evaluation models 524 may be initialized, trained, or established in accordance with unsupervised learning. For instance, the evaluation model 524 may be a clustering model, such as hierarchical clustering, centroid-based clustering (e.g., k-means), distribution model (e.g., multivariate distribution), or a density-based model (e.g., density-based spatial clustering of applications with noise (DBSCAN)), among others. Other techniques may be used to initialize, train, and establish the evaluation models 524, such as weakly supervised learning, reinforcement learning, and dimension reduction, among others.

In some embodiments, the model manager 516 in conjunction with the feature evaluator 514 may identify or select the evaluation model 524 from the set of evaluation models 524 to be trained. The selection may be based on the subset of datasets 530″, the feature to be evaluated, or the topic category identified in the tags 532 of the selected subset, among others. For instance, each evaluation model 524 may be dedicated or configured to process subsets of datasets 530″ for a particular feature or by extension category topic. The model manager 516 may identify the evaluation model 524 to be used to process the identified subset of datasets 530″. In some embodiments, the model manager 516 may determine whether an evaluation model 524 exists or is otherwise established for the feature. If the evaluation model 524 does not exist, the model manager 516 may create and initialize the evaluation model 524. For example, the model manager 516 may instantiate the evaluation model 524 for processing the datasets 530″ for the feature to be evaluated. Otherwise, if the evaluation model 524 does exist, the model manager 516 may use the evaluation model 524 to continue training using the selected subset of datasets 530″.

In some embodiments, the model manager 516 may select or identify a testing dataset and a validation dataset from the subset of datasets 530″. The model manager 516 may select, define, or otherwise assign a portion of the subset of datasets 530″ as the testing dataset. In addition, the model manager 516 may select, define, or otherwise assign a remaining portion of the subset of datasets 530″ as the validation dataset. The testing dataset may be used as input to the evaluation model 524 to generate a predicted output and the validation dataset may be used to as the expected output to check the predicted output against. The checking of the expected output form the validation dataset with the predicted output from inputting the testing dataset into the evaluation model 524 may be used to update the parameters of the evaluation model 524. With the definition of the testing and validation datasets, the model manager 516 may provide or pass datasets 530″ corresponding to the testing dataset to the model applier 518 to apply to the identified evaluation model 524.

The model applier 518 executing on the data processing system 502 may apply at least one of the evaluation models 524 to the subset of datasets 530″ (e.g., the test dataset). With the selection of the evaluation model 524, the model applier 518 may feed the subset of datasets 530″ into the inputs of the evaluation model 524. In feeding, the model applier 518 may process the input dataset 530″ in accordance with the parameters of the evaluation model 524. From processing with the evaluation model 524, the model applier 518 may produce or generate at least one output 534 for the input dataset 530″. The output 534 may correspond to, identify, or otherwise measure a predicted usefulness, risk level, performance metric, health level, among others. For example, for an input dataset 530″ with application-related data, the output 534 may identify a likelihood that a particular feature of the application is deprecated or in current use.

The model applier 518 may apply the parameters of the evaluation model 524 in accordance with the model architecture. For example, when the evaluation model 424 is an artificial neural network, the model applier 518 may process the input dataset 530″ using the kernel weights of the artificial neural network to generate the output 534. The output may indicate a degree of usefulness, risk, performance, or health for the input dataset 530″. When the evaluation model 524 is a clustering model, the model applier 518 may identify the output 534 from where the input dataset 530″ is situated within a region of the feature space defined by the clustering model. The region may correspond to a classification for the input dataset 530″ indicating usefulness, risk level, performance metric, or health level, among others.

Using the output 534, the model manager 516 may calculate, determine, or otherwise generate at least one feedback 536 for the evaluation model 524. The generation of the feedback 536 may be in accordance with the learning technique used to establish or train the evaluation model 524. In some embodiments, the model manager 516 may validate the evaluation model 524 using the output 534 and at least a portion of the datasets 530″ (e.g., the validation dataset). When supervised learning is used, the model manager 516 may compare the output 534 from the input dataset 530″ of the test dataset with the expected output. The expected output may be acquired or obtained from the validation dataset. Based on the comparison, the model manager 516 may determine the feedback 536 to indicate an amount of deviation between the predicted output 534 and the expected output. When unsupervised learning is used, the model manager 516 may determine a shift in parameters for the evaluation model 524 to use at the feedback 536. For instance, for a clustering model, the feedback 536 may indicate the amount that a centroid for a particular classification is to be modified based on the newly fed input datasets 530″. According to the feedback 536, the model manager 516 may modify, change, or otherwise update the parameters of the evaluation model 524.

The model manager 516 may update and re-train the evaluation models 524 any number of times, and repeat the operations discussed above. For example, the model manager 516 in conjunction with the feature evaluator 514 may identify another subset of datasets 530″ for a feature to be evaluated from another (e.g., subsequent) time period. With the identification, the model manager 516 may select the evaluation model 524 to process the subset of datasets 530″. The model applier 518 may apply the selected evaluation model 524 to the subset of datasets 530″ (along with the tags 532) to generate the output 534. Using the output 534, the model manager 516 may determine the feedback 536 with which to update the parameters of the evaluation model 524. The data processing system 502 may switch between the training mode to retrain, update, or fine-tune the evaluation model 524, and the runtime mode to apply the evaluation models 524 to newly acquired data.

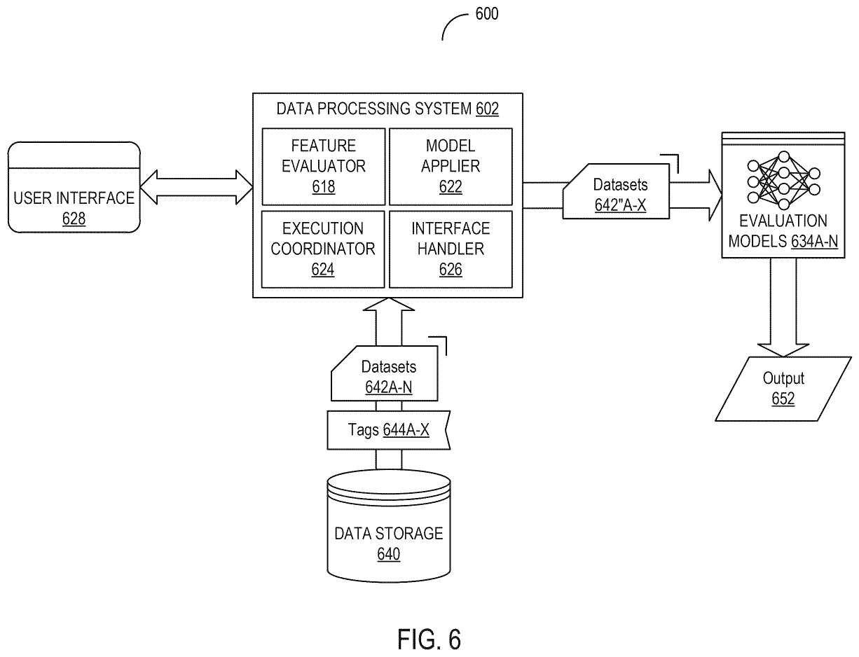

FIG. 6 depicts a block diagram of a system for processing aggregated data using ML models. The system 600 may include at least one data processing system 602. The data processing system 602 may include at least one feature evaluator 618, at least one model applier 622, at least one execution coordinator 624, at least one interface handler 626, one or more evaluation models 634A-N (hereinafter generally referred to as evaluation models 634), and at least one data storage 640, among others. In the system 600, the data processing system 602 and its components may be in a runtime or evaluation mode to apply at least one of the evaluation models 634 to new incoming data. Embodiments may comprise additional or alternative components or omit certain components from those of FIG. 6 and still fall within the scope of this disclosure. Various hardware and software components of one or more public or private networks may interconnect the various components of the system 600. Each component in system 600 (such as the data processing system 602 and its subcomponents) may be any computing device comprising one or more processors coupled with memory and software and capable of performing the various processes and tasks described herein.

The interface handler 626 executing on the data processing system 602 may provide the user interface 628 with which to select the feature to be evaluated using at least one of the evaluation models 634. The interface handler 626 may provide the user interface 628 for presentation on a display coupled with the data processing system 602 or a computing device (e.g., administrator's computing device) in communication with the data processing system 602. The user interface 628 may include one or more user interface elements (e.g., command button, radio button, check box, slider, or text box) for identifying or selecting the feature (or the topic category) to be evaluated. For instance, the user interface 628 may include a set of user interface elements corresponding to a menu of features from which the user can check or select for analysis. With the presentation, the interface handler 626 may monitor the user interface 628 for at least one input by the user. The interface handler 626 may use event handlers in the user interface elements of the user interface 628 to monitor. Upon detection of the input on the user interface 628, the interface handler 626 may obtain, identify, or otherwise receive the selection of the feature to be evaluated. The input may correspond to a user interface on the user interface element of the user interface 628. The feature may correspond to the user interface element in the user interface 628 on which the input is detected.

The feature evaluator 618 executing on the data processing system 602 may identify or select a subset of datasets 642″A-X (hereinafter generally referred to as datasets 642″) using at least one feature for evaluation using at least one of the evaluation models 634. The datasets 642″ may be selected from the set of datasets 642A-X (hereinafter generally referred to as datasets 642) on the data storage 640. The feature may correspond to at least one topic category for the datasets 642″ to be evaluated or analyzed for at least one metric, such as utility, risk level, performance, health, among others. The subset of datasets 642″ may be obtained, received, or otherwise retrieved from over a period of time. The period of time may correspond to a sampling window over which the datasets were generated at each data source. The period of time for the datasets 642″ for evaluation may differ from the period of time of datasets that were used to initialize, train, and establish the evaluation models 634.

In some embodiments, the feature evaluator 618 may select or identify the subset of datasets 642″ using the selection of the feature via the user interface 628. In some embodiments, the feature evaluator 618 may find, select, or otherwise identify a set of tags 644A-X (hereinafter generally referred to as tags 644) corresponding to the selected feature. The tag 644 may identify the topic category for each associated dataset 642″. The topic category defined by the tag 644 may correspond to the feature to be evaluated for the metric (e.g., utility or risk level). With the identification, the feature evaluator 618 may select or identify the subset of datasets 642″ using the tag 644 corresponding to the selected feature. In some embodiments, the feature evaluator 618 may identify the segment corresponding to the subset of datasets 642″ (e.g., previously defined by the tag generator) stored on the data storage 640. The segment may correspond to the datasets 642″ associated with the selected feature.

In conjunction, the feature evaluator 618 may identify or select the evaluation model 634 from the set of evaluation models 634 to be used to process the dataset 642″. The selection may be based on the subset of datasets 642″, the feature to be evaluated, or the topic category identified in the tags 644 of the selected subset, among others. For instance, each evaluation model 634 may be dedicated or configured to process subsets of datasets 642″ for the selected feature or by extension category topic. In general, each evaluation model 634 may have: at least one input corresponding to the subset of datasets 642″, at least one output from processing the input, and a set of parameters (e.g., weights) to process the inputs to generate the output. To train the evaluation model 634, the feature evaluator 618 may invoke the model applier 622 to apply the identified datasets 642″.

The model applier 622 executing on the data processing system 602 may apply or execute at least one of the evaluation models 634 to the subset of datasets 642″ identified using the selected feature. With the selection of the evaluation model 634, the model applier 622 may feed the subset of datasets 642″ into the inputs of the evaluation model 634. In feeding, the model applier 622 may process the input dataset 642″ in accordance with the parameters of the evaluation model 634. From processing with the evaluation model 634, the model applier 622 may produce or generate at least one output 652 for the input dataset 642″. The output 652 may correspond to, identify, or otherwise include a predicted metric associated with the feature. The predicted metric may include, for instance, a predicted usefulness, risk level, performance metric, health level, among others. For example, for an input dataset 642″ with application-related data, the output 652 may identify a likelihood that a particular feature of the application is deprecated or in current use.

In some embodiments, the model applier 622 may apply or execute the evaluation models 634 including at least generative model using the subset of datasets 642″. In some embodiments, the model applier 622 may execute the evaluation model 634 using the subset of datasets 642″ and the associated tags 644. In executing, the model applier 622 may create a prompt using the subset of datasets 642″ and a directive (e.g., in the form of natural language) for the evaluation models 634 to output for the given feature. With the creation of the prompt, the model applier 622 may provide the prompt to the evaluation model 634. Based on the execution of the evaluation model 634, the model applier 622 may determine or generate the output 652 including the predicted metric associated with the feature. The output 652 may be in a natural language form, with an indication of the predicted metric along with an identification of the feature and an explanation for the metric.

In some embodiments, the model applier 622 may use the evaluation model 634 to perform anomaly detection in the subset of datasets 642″ for the selected feature. From executing the evaluation model 634, the model applier 622 may produce or generate a set of embeddings. The set of embeddings may be a lower or reduced dimensional representation of latent features within the input datasets 642″. The set of embeddings may be associated with or correspond to at least one of the datasets 642″. The model applier 622 may apply or execute a clustering model (e.g., in the set of the evaluation models 634) using the set of embeddings. The clustering model may have been initialized, trained, and established using a training set of embeddings. The clustering model may include a set of clusters defined in a feature space. The feature space may have a number of dimensions corresponding to a number of dimensions in the set of embeddings. One or more clusters may be correlated or associated with non-anomalous data, and one or more other cluster may be associated with anomalous data. Each cluster may be identified by one or more characteristics, such as a presence or absence or the anomaly, a performance issue, a mitigation measure to address the anomaly or performance issue, or a security vulnerability in the network, among others.

From executing the clustering model, the model applier 622 may identify or determine a set of clustering assignment for the set of embeddings for each dataset 642″. Each clustering assignment may indicate or identify a corresponding cluster to which a respective set of embeddings of a respective dataset 642″ is assigned. Based on the clustering assignments, the model applier 622 may generate or determine the output 652. The output 652 may indicate a likelihood of at least one of an anomaly, a performance issue, a mitigation measure to address the performance issue, or a security vulnerability in the network environment, among others. For instance, the model applier 622 may identify the one or more characteristics associated with the cluster to which the set of embeddings is associated.

In some embodiments, the execution coordinator 624 on the data processing system 602 may coordinate or orchestrate execution of the evaluation model 634 (e.g., when a generative model is selected) with one or more external generative models to generate the output 652. The external generative models may be hosted or executed on services, separate from the data processing system 602. The external generative models may be a generative model, such as generative pre-trained transformer (GPT), bidirectional encoder representations from transformers (BERT), or recurrent neural network (RNN), among others. In some embodiments, at least one external generative model may have been trained using domain-specific training data (e.g., for a particular application, function, or feature). At least one of the external generative models may have been trained or fine-tuned to detect anomalies from datasets and to generate a report identifying one or more factors (or causes) for the detection of the anomaly.

In coordinating in concert with the external generative model, the execution coordinator 624 may pass at least a portion of the datasets 642″ from the evaluation model 634 to the external generative model. In some embodiments, the execution coordinator 624 may pass the portion of the datasets 642″ and the indication of the anomaly from the evaluation model 634 to the external generative model. From the execution of the evaluation model 634 in concert with the external generative model, the execution coordinator 624 may generate the output 652 using the datasets 642″. In some embodiments, based on providing the input to the external generative model, the execution coordinator 624 may generate additional output. The output 652 may include one or more of: an indication of a presence (or absence) of an anomaly in the network environment or a report identifying contributory factors for the indication of the presence (or absence) of the anomaly from the datasets 642″. In some embodiments, the additional output may include an explanation (e.g., in natural language form) for the anomaly as detected using the datasets 642″.

In one use case, the evaluation model 634 may act as the orchestrator model and receive the datasets 642″. The evaluation model 634 may coordinate with multiple other external generative models. Each external generative model may be trained or fine-tuned for a particular function or domain. The communication and delegation between these generative models may be through input prompts (including at least a portion of the datasets 642″). The evaluation model 634 in conjunction with the execution coordinator 624 may break down a complex task into sub-tasks. The evaluation model 634 may delegate these sub-tasks to other specialized generative models. For instance, one generative model may be fine-tuned for code generation, another for legal text interpretation, and a third for summarizing technical documentation. Each specialized generative model may process its sub-task and returns its output to the evaluation model 634, which then synthesizes the results.

For tasks requiring nuanced linguistic generation, deep semantic understanding, or problem-solving within a specific domain (e.g., generating complex code, drafting policy documents, performing complex textual analysis), the evaluation model 634 may delegate the sub-task to the specialized generative model (e.g., small language models). The external generative model may extend the capabilities of the evaluation model 634. In some embodiments, the evaluation model 634 may identify or select a tool for sub-tasks related to factual accuracy, real-time data, complex calculations, or interaction with external systems. The tools may be deterministic (e.g., separate from the external generative models). The evaluation model 634 may access a variety of external, deterministic tools (e.g., APIs, databases, code interpreters, search engines, or calculators).

The evaluation model 634 may select which tool to use, generate appropriate arguments, execute the tool, and then process the output from such tools. The tools may include, for example, a database query tool (e.g., for retrieving structured data from internal databases); an external service API tool (e.g., for interacting with other software systems or external services); a code interpreter tool (e.g., for executing code, performing calculations, or validating logic); or a web search tool (e.g., for current events, external facts, or public information), among others. Upon receiving a task, the evaluation model 634 may generate a sequence of actions. If an action relies on external data, computation, or interaction, the evaluation model 634 may create a tool call (e.g., a SQL query, an API request). The evaluation model 634 in conjunction with the execution coordinator 624 may execute the tool and process an output (e.g., the factual, deterministic information) from the tool. The evaluation model 634 may collect outputs from both the specialized generative models and the deterministic tools. The evaluation model 634 may then synthesize these diverse pieces of information and provides a comprehensive output (e.g., a response to be presented to a user).

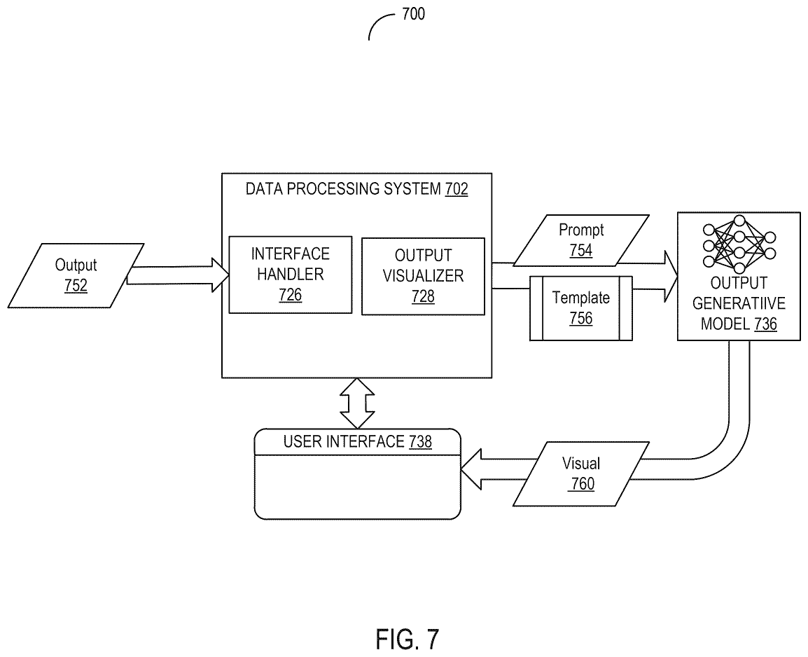

FIG. 7 depicts a block diagram of a system 700 for generating outputs from ML models. The system 700 may include at least one data processing system 702. The data processing system 702 may include at least one interface handler 726, at least one output visualizer 728, and at least one output generative model 736, among others. The data processing system 702 may provide at least one user interface 738. Embodiments may comprise additional or alternative components or omit certain components from those of FIG. 7 and still fall within the scope of this disclosure. Various hardware and software components of one or more public or private networks may interconnect the various components of the system 700. Each component in system 700 (such as the data processing system 702 and its subcomponents) may be any computing device comprising one or more processors coupled with memory and software and capable of performing the various processes and tasks described herein.

The interface handler 726 executing on the data processing system 702 may provide the user interface 738. The interface handler 726 may provide the user interface 738 for presentation on a display coupled with the data processing system 702 or a computing device (e.g., administrator's computing device) in communication with the data processing system 702. The user interface 738 may include one or more user interface elements (e.g., command button, radio button, check box, slider, or text box) for presenting information from outputs of the evaluation model. Once presented, the interface handler 726 may handle interactions between the user and the user interface elements to navigate the information.

The output visualizer 728 executing on the data processing system 702 may render, display, or otherwise present at least one visualization 760 of the output 752 on the user interface 738 using at least one template 756 for the feature. The output visualizer 728 may identify or select the template 756 from a set of templates for the set of potential features and by extension the topic categories for the tags. The selection of the template 756 may be based on the selected feature, the topic categories for the tag associated with the input dataset, the output 752 from the evaluation model, an evaluation model used to generate the output 752, among others. Each template 756 may be pre-generated or pre-configured for presenting the information from the output 752.

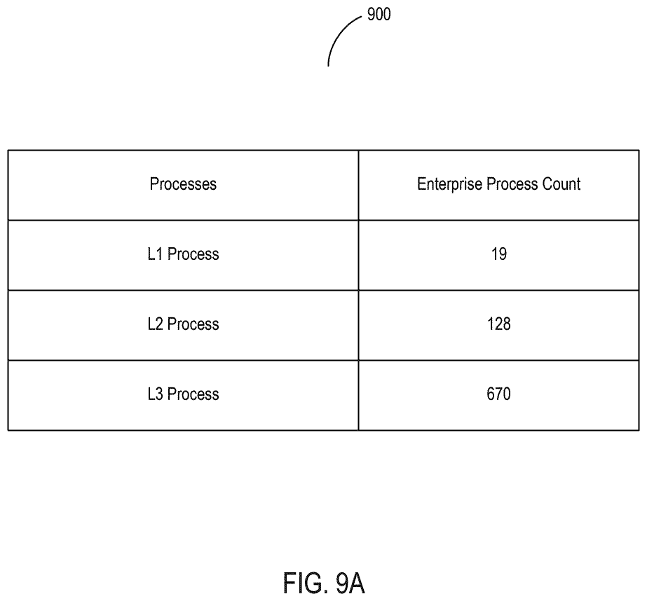

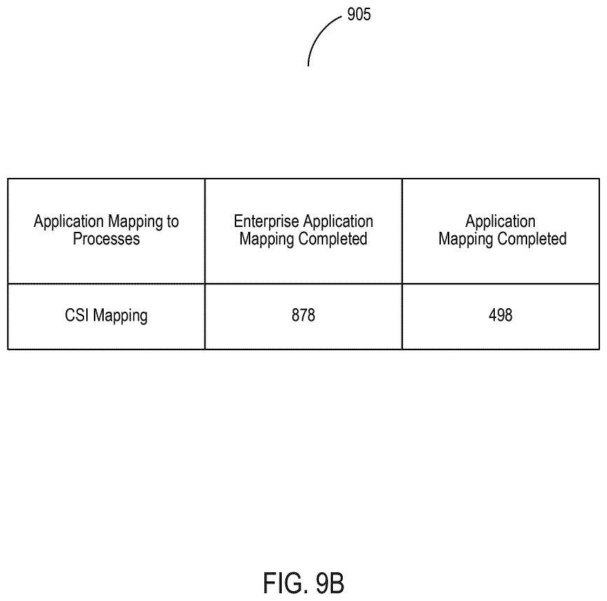

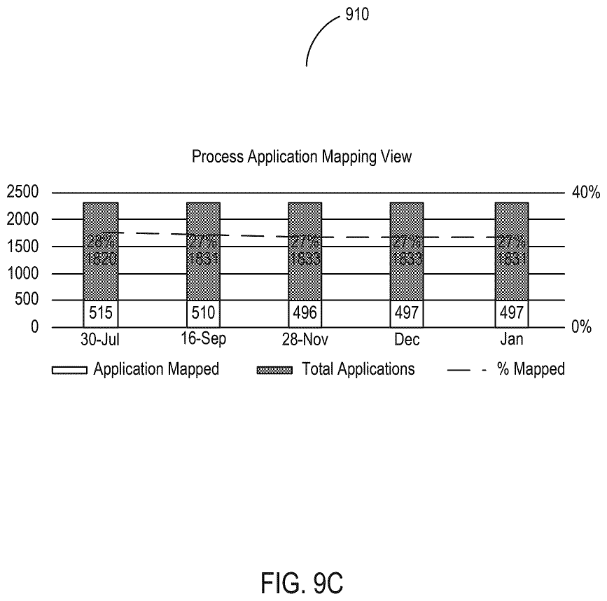

In accordance with the template 756, the output visualizer 728 may create, produce, or otherwise generate the visualization 760 of the output 752. The template 756 may define or specify a visualization of the information identified in the output 752. For example, the template 756 may specify the information (e.g., predicted usefulness, risk level, performance metric, or health level) as indicated in the output 752 to be presented in a bar graph, a table, a box plot, a scatter plot, a pie chart, a Venn diagram, histogram, or fan chart, among others. The template 756 may identify one or more user interface elements with which the user can use to drill down or navigate the information for the output 752. Using the specifications of the template 756, the output visualizer 728 may generate the visualization of the information as identified in the output 752. Examples of the visualizations are shown in FIGS. 9A-C.

In some embodiments, the output visualizer 728 may apply or execute the output generative model 736 using the output 752 from the evaluation model. In executing, the output visualizer 728 may create or generate at least one prompt 754 in accordance with a prompt template for the feature. The prompt template may include a set of defined strings (e.g., a directive or command to generate a particular visualization, such as a bar graph, a table, a box plot, a scatter plot, a pie chart, a Venn diagram, histogram, or fan chart) for the particular feature, along with a set of placeholders for insertion of the output 752 to be visualized. The output visualizer 728 may provide the prompt 754 as input to the output generative model 736. Based on providing the prompt 754 as input to the output generative model 736, the output visualizer 728 may generate the visualization 760 of the output 752.

In one use cases, upon initiation, a data processing system 702 may perform anomaly detection in the network environment or a particular feature using the datasets 742″. The data processing system 702 may invoke a data fetch tool via a command to pull datasets 742 (e.g., raw logs, metrics, and events from disparate data sources, such as databases or streaming APIs). The data processing system 702 may pass the data to a data augmenter to clean, normalize, and semantically tag data. The data processing system 702 may select a generative model (e.g., one of the evaluation models for unsupervised anomaly detection or supervised classification) and feed the prepared, tagged data to the generative model. Based on the tags, the evaluation model may generate anomaly scores for the data. If the evaluation model output indicates an anomaly, the evaluation model acting as the orchestrator can send the flagged data and results to another generative model. The second generative model may interpret the anomaly score in context, cross-references with common issues, and generate output with the human-readable root causes. With the output, the data processing system 702 may invoke an output visualizer model to create an output for presentation. The output may include a prioritized incident ticket for the system administrator, an alert to a user or relevant team, or an update to the dashboard interface, among others.

In this manner, the data processing system may reduce the amount of time and effort spent by user in trying to manually track down individual data sources to track and fetch data by retrieving datasets originally stored across disparate data sources in the network environment. The aggregation and ingestion may eliminate manual data collection and integration, which can be error-prone and resource-intensive, thereby improving the efficiency and scalability of network management. With the ready retrieval of the datasets, the data processing system may use intake generative models to process and normalize data for unified processing by evaluation models. To that end, the data processing system may use a semantic knowledge graph that captures relationships and equivalences between terms and concepts across different data sources to determine the appropriate category taxonomies and their respective tags to add to the data. This may allow for resolution of inconsistencies in terminology and structure, enabling more meaningful and actionable analysis than statistical or rule-based approaches. The addition of complete and accurate data may also improve the reliability of the analytics and estimates generated by the evaluation models.

The data processing system may use policies to perform quality checks (e.g., integrity, consistency, accuracy, completeness) and to enforce compliance policies (such as data minimization or PII removal) automatically. The use of policies along with the intake generative model can lessen the reliance for static, manually coded rules, thus minimizing the risk of non-compliant or low-quality data entering downstream processes. The data processing system may transform the datasets in a manner amenable for processing by evaluation models. Using the tags and features, the data processing system can select from a set of evaluation models (e.g., supervised, unsupervised, or generative) to carry out a particular task on a segment of data. This approach can provide for more precise and context-aware processing, supporting a wide range of use cases (e.g., anomaly detection, risk assessment, performance monitoring, and versioning). The ability to process the datasets for evaluation models can result in uncovering and detecting issues across multiple applications and processes in the network environment. With repeated training of the evaluation models using datasets with successive sampling periods, the data processing system may be able to provide more accurate and refined output.

Outputs from machine learning models may be translated into visualizations for the system administrator. The data processing system can also use the templates to produce visualizations for easy digestion via the dashboard information by the users. As such, problems affecting the performance of applications or processes on servers across the network may be quickly and readily pinpointed and addressed. In addition, the insight and information from these visualizations of the output may be used to assess and create a long-term (e.g., 1 to 10 years) strategy for improving performance and enhancing risk management of the overall network environment. The output generated by the data processing system may also improve the overall performance of the servers and client devices in the network, for instance, by reducing the computer and network resources tied up due to previously undetectable issues. By performing data ingestion, normalization, quality assurance, and analytics in this manner, the data processing system can reduce the computational and time resources required for data management across an array of different sources.

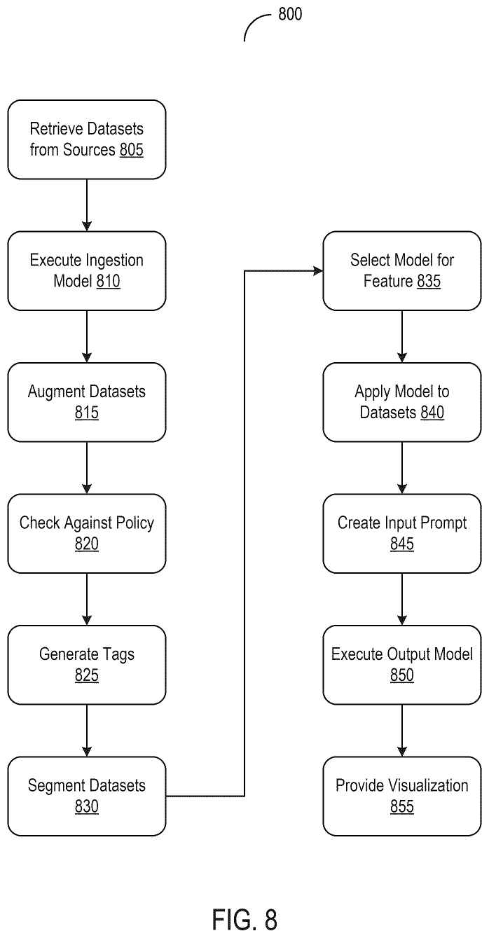

FIG. 8 depicts a flow diagram of a method 800 of aggregating data from disparate sources to output information using ML models. Embodiments may include additional, fewer, or different operations from those described in the method 800. The method 800 may be performed by a service (e.g., a data processing system) executing machine-readable software code, though it should be appreciated that the various operations may be performed by one or more computing devices and/or processors.

At step 805, a service may retrieve datasets from data sources. Each of the data sources may store and maintain datasets, in accordance with the specification of the data source. The specifications may include a format and contents for datasets to be stored and maintained at the data source. The data for the datasets may be generated by various applications, processes, and computing devices in the computing network (e.g., enterprise network). The service may retrieve the datasets from these data sources over a period of time.

At step 810, the service may execute an ingestion model using the received datasets. At step 815, the service may transform each dataset from the original formatting to a formatting for application to one of a set of machine learning models. In addition, the service may use an intake generative model to perform data correction or augmentation for missing data in the converted datasets. At step 820, the service may check the datasets against a policy to identify and correct non-compliant data. At step 825, the service may generate tags for each dataset using the contents (e.g., fields or values) of the dataset using the intake generative model and a semantic knowledge graph. The tag may identify a topic category for the dataset. At step 830, the service may segment the datasets by the topic categories as identified in the tags.

At step 835, the service may select a machine learning model for evaluating the dataset. The service may maintain a set of machine learning models (e.g., supervised, unsupervised, or generative models). Each model may be dedicated to or configured to process datasets for certain topic categories. The service may select the model based on the feature or topic category to be evaluated. At step 840, the service may apply the selected model to the segment of datasets identified using the tags. In applying, the service may process the segment of datasets in accordance with the parameters of the machine learning model to generate an output.

At step 845, the service may create an input prompt for the creation of a visualization of the output from the machine learning model. The prompt may specify a form for visualizing the information identified in the output from the model. The template with which to generate the prompt may be identified using the feature or topic category analyzed from applying the machine learning model to the segment of dataset. At step 850, the service may execute an output generative model to create the visualization of the output in accordance with the template. At step 855, with the generation, the service may present the visualization of the information of the output on a dashboard interface.

FIGS. 9A-C depict screenshots of visualizations 900-910 of processes and application mapping presented on a dashboard interface. The visualization 900 may provide a view of level 1 (L1), level 2 (L2), and level 3 (L3) processes in L1, L2, L3 business process taxonomy defined to have a common vocabulary for the classification of business processes that facilitates easier communication, governance, and reporting, helping improve diverse stakeholder alignment and managements in a table view. L1 may correspond to a lifecycle of services provided internally and externally through the enterprise and may be outside of a line (e.g., a process) and may be unique to a specific function (e.g., addition of a user). L2 may correspond to a logical order of processes directly underpinning the delivery of the L1 and may be not overly specific to a particular function or business or the same as a L1 (e.g., account opening and setup). L3 may correspond to unique and distinct processes needed to complete the L2 process, and may be anything other than a process step that is to connect to a L2 process (e.g., Know Your Customer (KYC) onboarding review). The visualization 905 may provide a view on a number of enterprise and sector applications mapped to distinct processes, among others, in a table view. The visualization 910 may provide the view of total applications which are mapped and not mapped to the process defined to services in a table view.

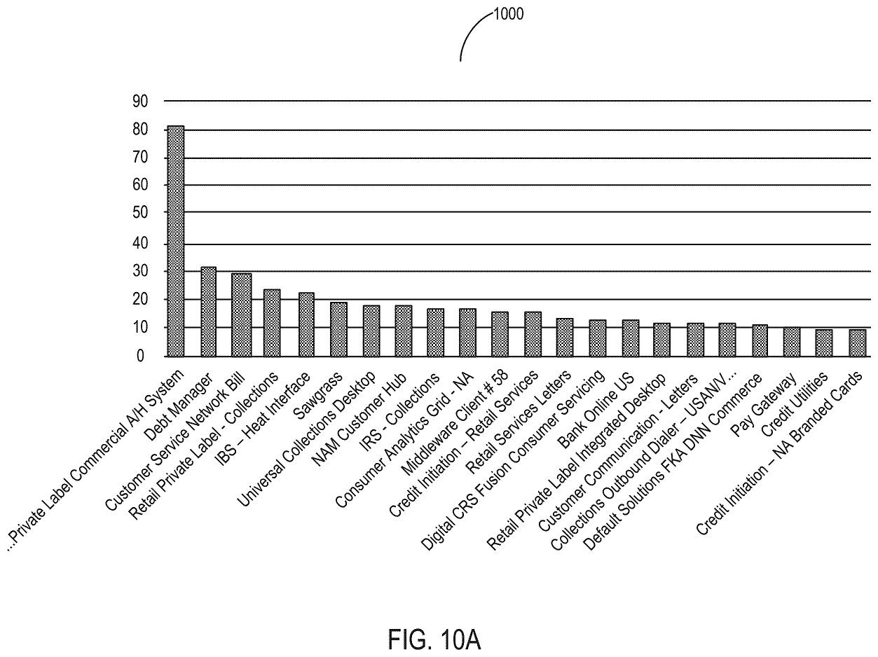

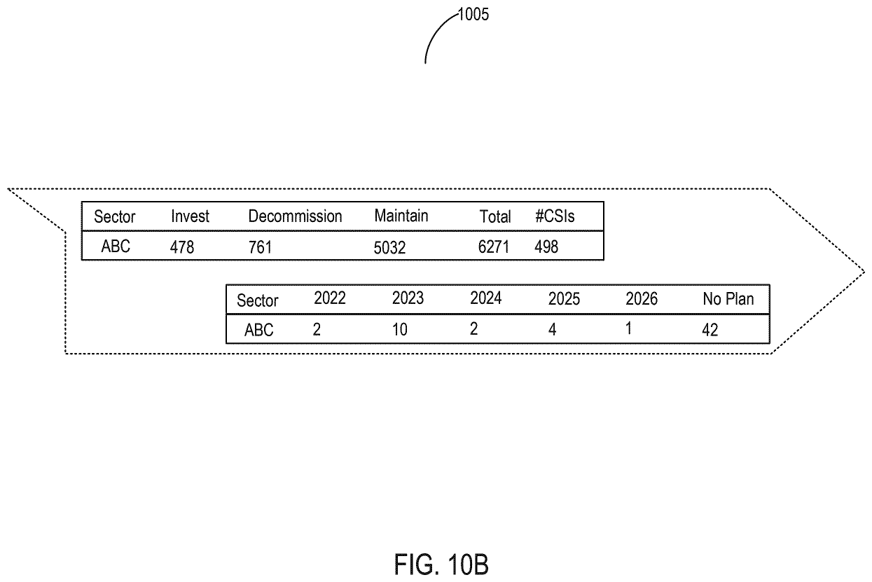

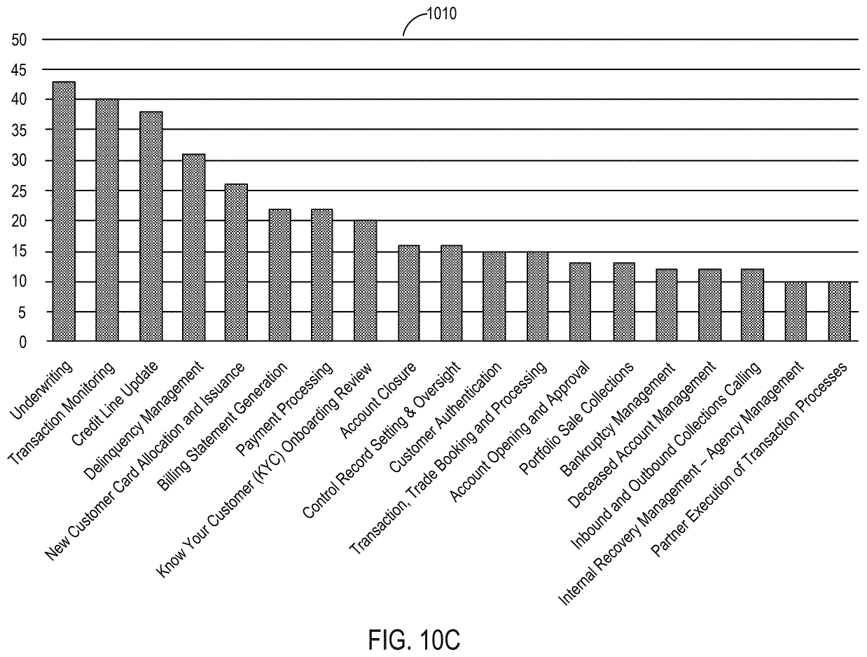

FIGS. 10A-C depict screenshots of visualizations 1000-1010 characterizing applications generated as presented on a dashboard interface. The visualizations 1000-1010 may identify how the applications can provide recommendations regarding process cycles, leveraging the evaluations models and insights. The visualization 1000 may provide a histogram view of multiple technology applications supporting more than business functions for a particular line of and can identify opportunities to optimize as part of target state. The visualization 1005 may be a timeline view of a number of applications to be decommissioned, maintained, or updated, among other statistics. The visualization 1005 may identify mapping of functions such as (1) customer information collection, (2) customer account review, (3) account set up, and (4) checking creation and delivery along with tags of invest, decommission, or maintain. The visualization 1005 may also provide how many applications can be decommissioned over time. The visualization 1010 may provide a bar chart view of multiple processes that are supported by more than or equal to ten applications for a particular line or group in the enterprise.

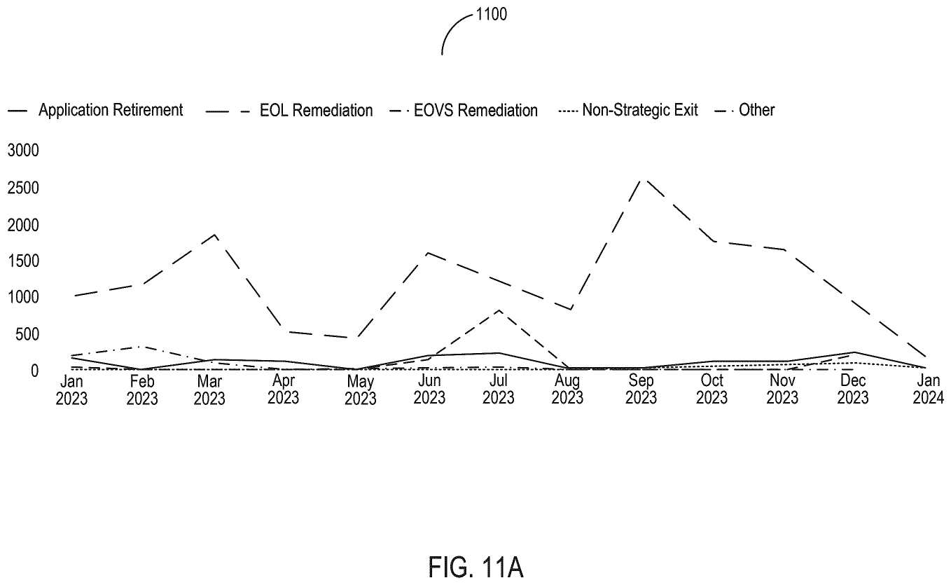

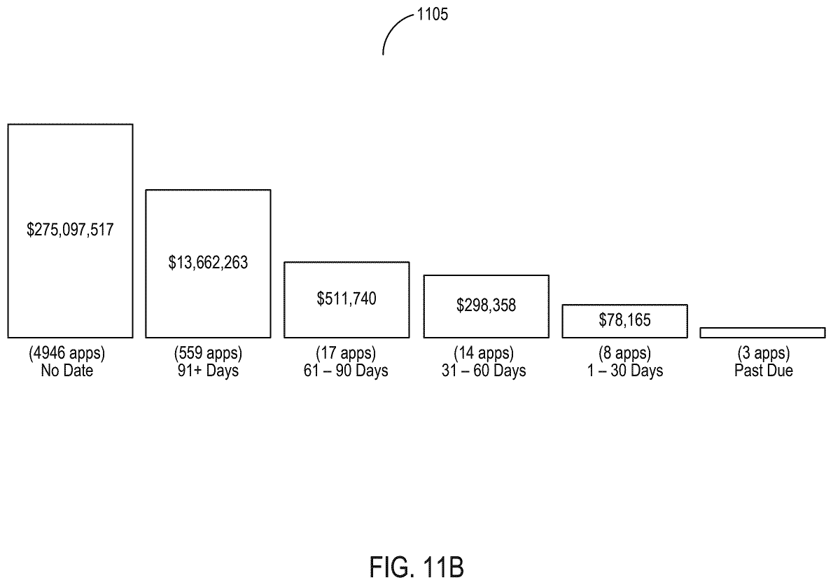

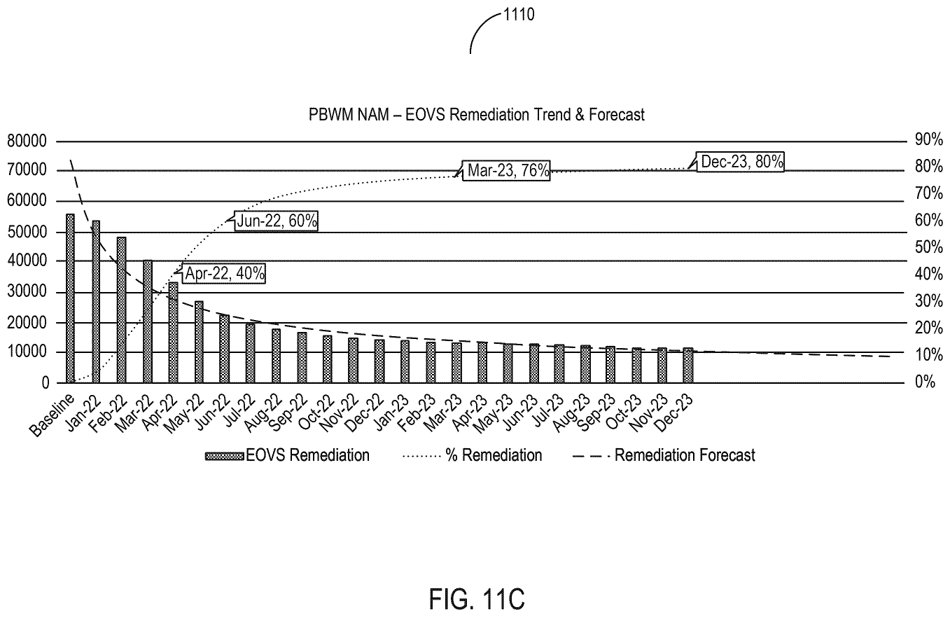

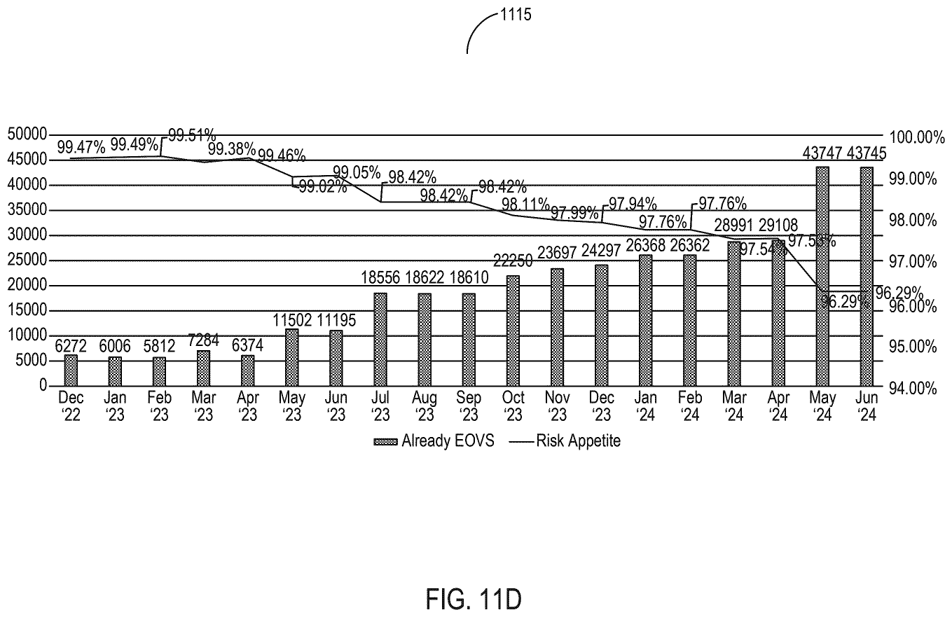

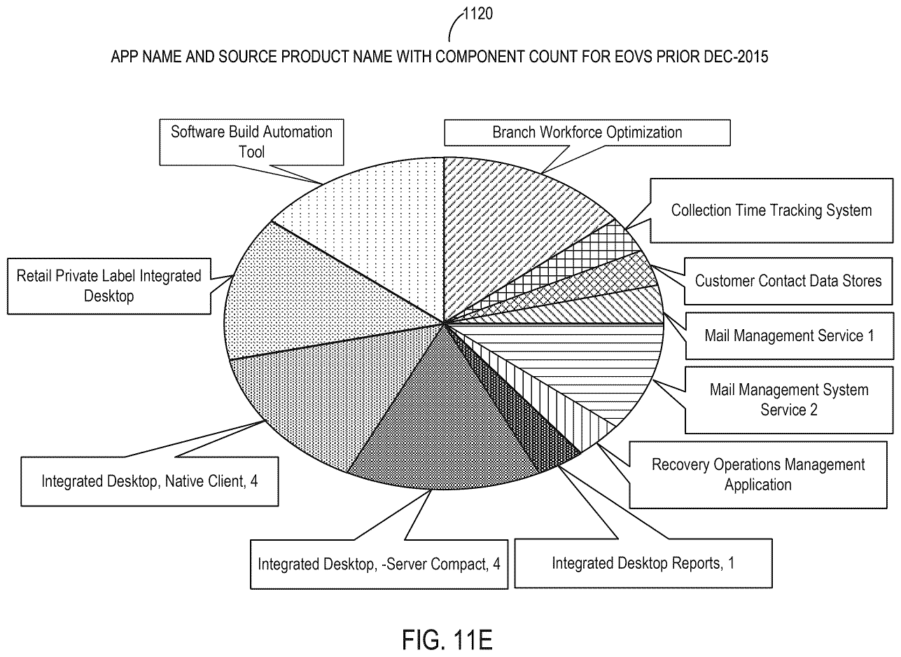

FIGS. 11A-E depict screenshots of visualizations 1100-1120 of risk factors from application processes as presented on a dashboard interface. The visualization 1100 may be a graph of the forecasting of application decommissions. The visualization 1100 may show the forecast of retirement of applicable applications, remediation of application components that are end of life (EOL), remediation of application components that are end of vendor support (EOVS) and other decommissioning or remediation details for the next year. The visualization 1105 may be a histogram, or multiple histograms, showing monetary values for retiring various applications. In the visualization 1105, the summary of the application retirement status and the monthly chargeback details for applications that are past due and for applications that would be due within 180 days are visualized with the ingested data.

The visualization 1110 may be a summary graph of trends and forecasts for remediating applications. The visualization 1110 may provide the end of vendor support remediation projection for application components within a particular sector are depicted along with the projected trend and forecast for the EOVS remediation. The visualization 1115 may be a graph of a risk appetite across time. The visualization 1115 shows the risk appetite forecast against monthly open end of vendor support (EOVS) components. This chart forecast the risk appetite for the next 12 months and indicates the number of EOVS items that needs to be remediated to mitigate the risk (Risk Appetite: color 1>=99.4%, color 2 between 99.0% and 99.4% and color 3<99.0%). The visualization 1120 may be a pie chart of component counts for various applications. In the visualization 1120, the pie chart may list the impacted applications and the corresponding component count that are still end of vendor support (EOVS) from December 2015 and not yet remediate.

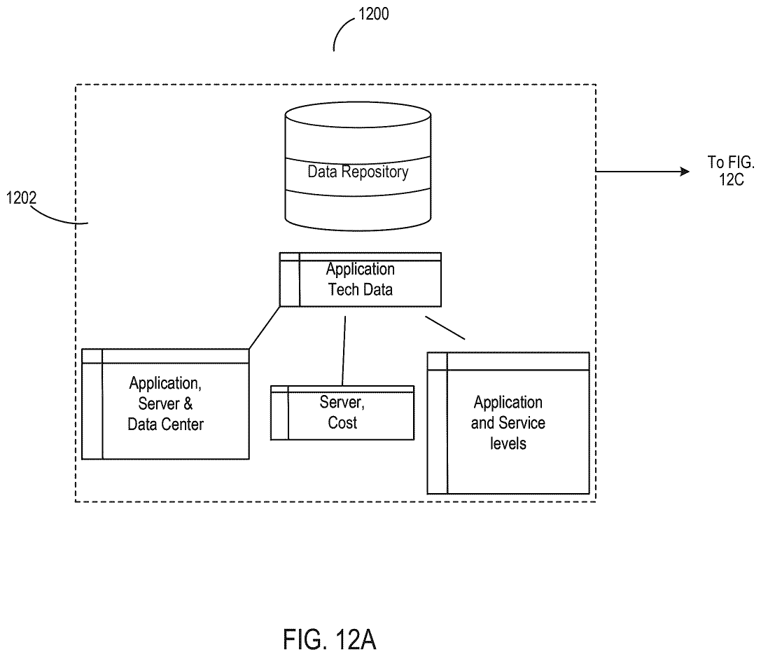

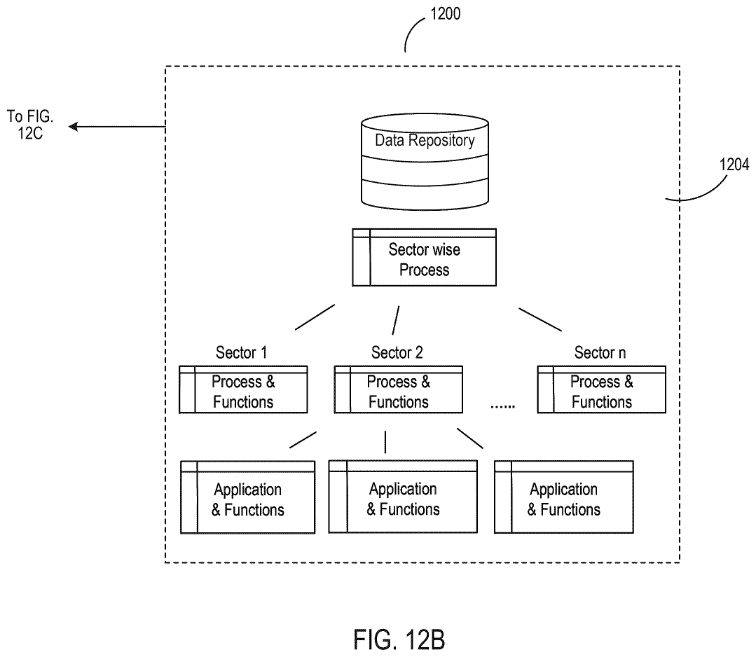

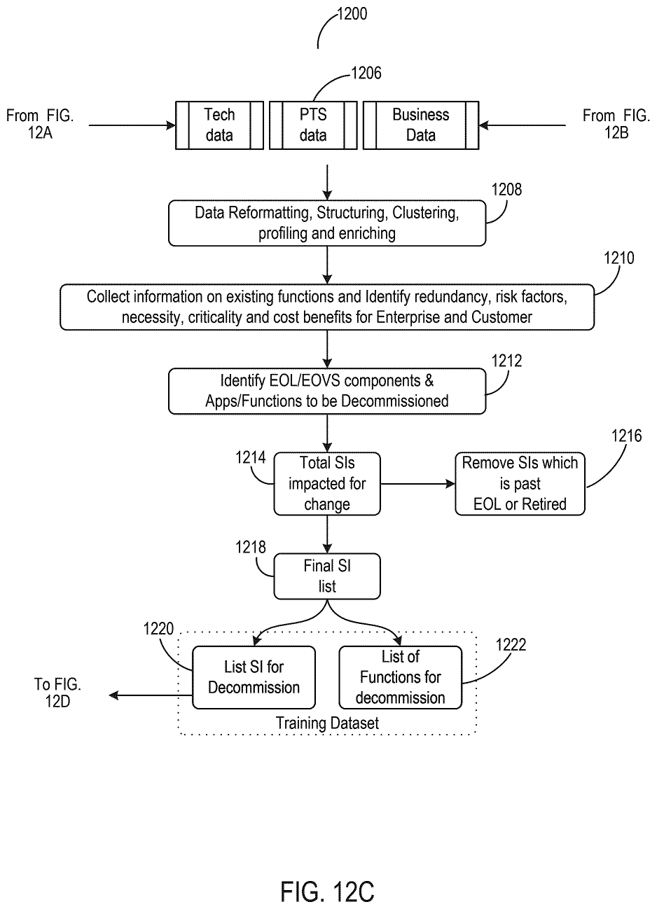

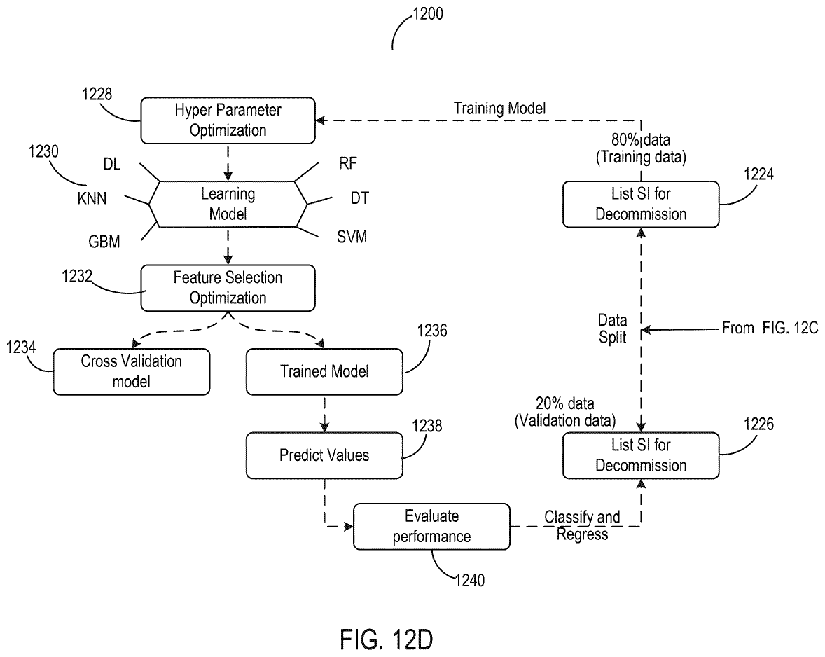

FIGS. 12A-D depict a flow diagram of a method 1200 for aggregating data related to applications and outputting information on application commission using ML models. Embodiments may include additional, fewer, or different operations from those described in the method 1200. The method 1200 may be performed by a service (e.g., a data processing system) executing machine-readable software code, though it should be appreciated that the various operations may be performed by one or more computing devices and/or processors. Starting from FIG. 12A, a service may access data from a data repository 1202. The data repository may include application tech data including information related to application, server, and data center, server costs, and application and service level agreements, among others. In conjunction, moving onto FIG. 12B, the service may access data from a sector data repository 1204). The sector data repository may include data for processes with functions and applications with functions from individual sectors 1 through n.

Continuing onto FIG. 12C, the service may aggregate the data from multiple data sources 1206. The data sources may include from the data repository 1202 or the sector data repository 1204, as well as from a project tracking system (PTS). The PTS may be a management tool used to create and maintain projects, budgets, forecast and actual in both full time equivalent (FTE), as well as the status and the start or end date for each project. The PTS may also allow managers to track resource allocation. With the aggregation, the service may reformat, structure, cluster, profile, and enrich the aggregated data 1208. In addition, the service may collect information on existing functions to identify redundancies, risk factors, necessity, criticality, and cost benefits for the enterprise network and customers 1210. The service may identify components, applications, and functions to be decommissioned in the aggregated data 1212. The components may be at an end of life (EOL) in which the component vendor has announced that maintenance and extended support is to be terminated. The components may be at an end of vendor support (EOVS) in which the vendor for the component announced that publicly available extended support is to end for a given product version. The service may determine a total number of system inventory items (Sis) impacted 1214. The SI may identify profiles of applications and may aggregate details from messages, user interfaces, infrastructure or software deployment details, and other information. From the total number, the service may remove SIs which are past the EOL or retired 1216. The service may then compile a final SI list 1218. The service may generate training and validation datasets including a list of SIs for commissions and a list of functions for decommission 1220 and 1222.

Referring now to FIG. 12D, the service may split the data by using the 80% of the list of SI for decommission as training data 1224 and using the remaining 20% for validation (1226). The service may use the training dataset to perform hyper parameter optimization 1228. The service may use one or more learning models to train, such as a deep learning model, a nearest neighbors' model, a decision tree, a radio frequency mode, a gradient boosting machine, or a support vector machine, among others 1230. The service may perform a feature selection optimization 1232 to derive a cross-validation model 1234 and to generate a training model 1236. The service may use the trained model to generate predicted values 1238 and use the predicted values to evaluate performance 1240. The service may classify and regress the predicted values to add to the validation dataset.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of aggregating data from disparate sources using generative models, comprising:
retrieving, by one or more processors, from a plurality of data sources, a first plurality of datasets for at least one of a plurality of features for a network environment over a first time period;
executing, by the one or more processors, a first generative model using the first plurality of datasets to (i) identify one or more first datasets in the first plurality of datasets to be modified and (ii) generate one or more second datasets to substitute the one or more first datasets to create a second plurality of datasets;
identifying, by the one or more processors, from the second plurality of datasets, at least one dataset corresponding to a feature of the plurality of features;
selecting, by the one or more processors, from a plurality of machine learning (ML) models, at least one ML model based on the feature, the at least one ML model trained using a third plurality of datasets for the feature from one or more of the plurality of data sources over a second time period;
executing, by the one or more processors, the at least one ML model using the at least one dataset to determine an output including a predicted metric associated with the feature; and
causing, by the one or more processors, displaying of a visualization of the output via a graphical user interface.

2. The method of claim 1, wherein executing the at least one ML model further comprises:
executing a second generative model using the second plurality of datasets to generate a plurality of embeddings, each embeddings of the plurality of embeddings comprising a contextual representation of at least one of the second plurality of datasets,
executing, using the plurality of embeddings, a clustering model comprising a plurality of clusters defined in a feature space to determine a plurality of assignments for the plurality of embeddings, each of the plurality of assignments identifying at least one of the plurality of clusters to which a corresponding embedding of the plurality of embeddings is assigned; and
determining, based on the plurality of assignments, the output including the predicted metric indicating a likelihood of at least one of an anomaly, a performance issue, a mitigation measure to address the performance issue, or a security vulnerability in the network environment.

3. The method of claim 1, wherein executing the first generative model further comprises
identifying, from the one or more first datasets of the first plurality of datasets, one or more token representations, and
determining that the one or more token representations corresponds to one or more of a plurality of taxonomy categories in a semantic knowledge graph,
generating, for each of the one or more token representations, a respective tag identifying taxonomy category of the plurality of taxonomy categories.

4. The method of claim 1, wherein executing the first generative model further comprises:
identifying, from the one or more first datasets of the first plurality of datasets, one or more token representations;
determining that the one or more token representations do not correspond to any of a plurality of taxonomy categories in a semantic knowledge graph;
creating, for the semantic knowledge graph, at least one node corresponding to an additional taxonomy category to include the one or more token representations, responsive to determining that the one or more token representations do not correspond to any of the plurality of taxonomy categories; and
modifying, based on the additional taxonomy category, the one or more first datasets to generate the one or more second datasets.

5. The method of claim 1, further comprising:
identifying, by the one or more processors, a plurality of corpuses from one or more of the plurality of data sources,
executing, by the one or more processors, the first generative model using the plurality of corpuses to (i) identify a plurality of terms across the plurality of corpuses and (ii) determine a plurality of confidence scores for the plurality of terms, each of the plurality of confidence scores indicating a degree of relevance between a corresponding pair of terms in the plurality of terms; and
generating, by the one or more processors, using the plurality of terms and the plurality of confidence scores, a semantic knowledge graph comprising (i) a plurality of nodes corresponding to the plurality of terms and (ii) a plurality of edges, each edge of the plurality of edges defining a relationship between a corresponding pair of nodes for the corresponding pair of terms in the plurality of terms,
wherein executing the first generative model further comprises executing the first generative model and the semantic knowledge graph.

6. The method of claim 1, further comprising:
receiving, by the one or more processors, an electronic document defining one or more constraints on use of the plurality of first datasets;
executing, by the one or more processors, a second generative model using the electronic document to generate a data structure comprising a plurality of fields and a corresponding plurality of values to define the one or more constraints; and
storing, by the one or more processors, on a database, the data structure to apply the one or more constraints.

7. The method of claim 6, further comprising:
identifying, by the one or more processors, in accordance with the one or more constraints, one or more third datasets in the first plurality of datasets to be modified; and
generating, by the one or more processors in accordance with the one or more constraints, one or more fourth datasets to replace the one or more third datasets in the first plurality of datasets.

8. The method of claim 1, wherein executing the first generative model further comprises:
identifying, from the first plurality of datasets, at least one third dataset as not in conformance with at least one factor of a plurality of factors as defined by a data quality policy, wherein the plurality of factors comprises at least one of a data integrity factor, a data consistency factor, a data accuracy factor, a data completeness factor, or predefined factor, and
generating a second output indicating the at least one factor as cause for identifying the at least one third dataset as not in conformance with the data quality policy.

9. The method of claim 8, wherein executing the first generative model further comprises:
determining a score indicating a likelihood that the at least one third dataset as not in conformance with the at least one factor, and
generating the second output indicating the at least one factor as cause for identifying the at least one third dataset as not in conformance with the data quality policy, responsive to the score satisfying a threshold, further comprising:
generating, by the one or more processors, for storage on a database, a data record comprising at least one of: an indication of the at least one third dataset as not in conformance with the data quality policy, a source identifier corresponding to a data source of the plurality of data sources from which the at least one third dataset is retrieved, or the score.

10. The method of claim 1, wherein executing the first generative model further comprises:
selecting, from a plurality of second generative models, a second generative model based on the feature to be evaluated,
providing, as input to the second generative model, the first plurality of datasets, and
generating, based on providing the input to the second generative model, the one or more second datasets to substitute the one or more first datasets to create the second plurality of datasets.

11. The method of claim 1, wherein selecting the at least one ML model further comprises selecting a second generative model, and
wherein executing that least one ML model further comprises executing the second generative model to determine the output indicating a detecting of an anomaly in the network environment and including a report identifying one or more factors for the detection of the anomaly.

12. The method of claim 1, further comprising:
generating, by the one or more processors, a prompt using the output in accordance with a prompt template configured for the feature; and
executing, by the one or more processors, a second generative model using the prompt to generate the visualization of the output.

13. A system for aggregating data from disparate sources using generative models, comprising:
one or more processors coupled with memory, configured to:
retrieve, from a plurality of data sources, a first plurality of datasets for at least one of a plurality of features for a network environment over a first time period;
executive a first generative model using the first plurality of datasets to (i) identify one or more first datasets in the first plurality of datasets to be modified and (ii) generate one or more second datasets to substitute the one or more first datasets to create a second plurality of datasets;
identify, from the second plurality of datasets, at least one dataset corresponding to a feature of the plurality of features;
select, from a plurality of machine learning (ML) models, at least one ML model based on the feature, the at least one ML model trained using a third plurality of datasets for the feature from one or more of the plurality of data sources over a second time period;
execute the at least one ML model using the at least one dataset to determine an output including a predicted metric associated with the feature; and
causing displaying of a visualization of the output via a graphical user interface.

14. The system of claim 13, wherein the one or more processors are further configured to
execute a second generative model using the second plurality of datasets to generate a plurality of embeddings, each embeddings of the plurality of embeddings comprising a contextual representation of at least one of the second plurality of datasets,
execute, using the plurality of embeddings, a clustering model comprising a plurality of clusters defined in a feature space to determine a plurality of assignments for the plurality of embeddings, each of the plurality of assignments identifying at least one of the plurality of clusters to which a corresponding embedding of the plurality of embeddings is assigned; and
determine, based on the plurality of assignments, the output including the predicted metric indicating a likelihood of at least one of an anomaly, a performance issue, a mitigation measure to address the performance issue, or a security vulnerability in the network environment.

15. The system of claim 13, wherein the one or more processors are further configured to:
identifying, from the one or more first datasets of the first plurality of datasets, one or more token representations to at least one feature of the plurality of features, and
generating, using a semantic knowledge graph, for each of the one or more token representations, a respective tag identifying a category of a plurality of categories.

16. The system of claim 13, wherein the one or more processors are further configured to:
identify, from the one or more first datasets of the first plurality of datasets, one or more token representations to at least one feature of the plurality of features;
determine that the one or more token representations for the at least one feature do not correspond to any of a plurality of taxonomy categories;
create, for the at least one feature, an additional taxonomy category to include the one or more token representations, responsive to determining that the one or more token representations do not correspond to any of the plurality of taxonomy categories; and
modify, based on the additional taxonomy category, the one or more first datasets to generate the one or more second datasets.

17. The system of claim 13, wherein the one or more processors are further configured to:
identify a plurality of corpuses from one or more of the plurality of data sources,
execute the first generative model using the plurality of corpuses to (i) identify a plurality of terms across the plurality of corpuses and (ii) determine a plurality of confidence scores for the plurality of terms, each of the plurality of confidence scores indicating a degree of relevance between a corresponding pair of terms in the plurality of terms; and
generate, using the plurality of terms and the plurality of confidence scores, a semantic knowledge graph comprising (i) a plurality of nodes corresponding to the plurality of terms and (ii) a plurality of edges, each edge of the plurality of edges defining a relationship between a corresponding pair of nodes for the corresponding pair of terms in the plurality of terms,
execute the first generative model and the semantic knowledge graph.

18. The system of claim 13, wherein the one or more processors are further configured to:
receive an electronic document defining one or more constraints on use of the plurality of first datasets;
execute a second generative model using the electronic document to generate a data structure comprising a plurality of fields and a corresponding plurality of values to define the one or more constraints; and
storing, by the one or more processors, on a database, the data structure to apply the one or more constraints.

19. The system of claim 13, wherein the one or more processors are further configured to:
select, from a plurality of second generative models, a second generative model based on the feature to be evaluated,
provide, as input to the second generative model, a prompt based on at least a portion of the first plurality of datasets and the feature to be evaluated, and
generate, based on providing the input to the second generative model, the one or more second datasets to substitute the one or more first datasets to create the second plurality of datasets.

20. The system of claim 13, wherein the one or more processors are further configured to:
generate a prompt using the output in accordance with a prompt template configured for the feature; and
execute a second generative model using the prompt to generate the visualization of the output.
